(19) United States
(12) Patent Application Publication
(10) Pub. No.: US 2026/0367711 A1
(43) Pub. Date: Nov. 19, 2026

(54) CONFIGURABLE GESTURE-BASED OPERATION CONTROL

(71) Applicant: QUALCOMM Incorporated, San Diego, CA (US)

(72) Inventors: Dattaji Diliprao DHUMAL, Latur (IN); Praveenkumar BAGALI, Bagalkot (IN); Hari Prasad NARASIMHAIAH, Bangalore (IN)

(21) Appl. No.: 19/210,412

(22) Filed: May 16, 2025

(51) Int. Cl. G06F 3/01; H04M 1/72409; H04M 1/72454

(52) U.S. Cl. CPC G06F 3/017; G06F 3/012; H04M 1/724097; H04M 1/72454

(57) ABSTRACT

A device includes a memory configured to store gesture configuration data associated with at least one user-assigned gesture and at least one operation. The gesture configuration data maps each of the at least one user-assigned gesture to a respective operation of the at least one operation. The device also includes one or more processors coupled to the memory and configured to obtain sensor data from a sensor. The sensor data indicates movement of a wearable device. The one or more processors are also configured to determine a detected gesture based on the sensor data. The one or more processors are also configured to, based on the gesture configuration data indicating that the detected gesture matches one of the at least one user-assigned gesture, initiate a corresponding operation of the at least one operation.

### I. FIELD

The present disclosure is generally related to configurable gesture-based operation control.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to perform operations responsive to user input. For example, a user can tap on a device screen to answer a voice call. There are often instances when the user does not have a hand available to make physical contact with a device to provide user input. To illustrate, the user may be cooking, painting, driving, riding a bicycle, etc. when a voice call is received at the device. There is delay and inconvenience associated with the user having to stop what they are doing, possibly having to wipe their hands, to provide user input to the device.

### III. SUMMARY

According to one implementation of the present disclosure, a device includes a memory configured to store gesture configuration data associated with at least one user-assigned gesture and at least one operation, where the gesture configuration data maps each of the at least one user-assigned gesture to a respective operation of the at least one operation. The device also includes one or more processors coupled to the memory and configured to obtain sensor data from a sensor, where the sensor data indicates movement of a wearable device. The one or more processors are also configured to determine a detected gesture based on the sensor data. The one or more processors are configured to, based on the gesture configuration data indicating that the detected gesture matches one of the at least one user-assigned gesture, initiate a corresponding operation of the at least one operation.

According to another implementation of the present disclosure, a method includes obtaining, at a device, sensor data from a sensor, where the sensor data indicates movement of a wearable device. The method also includes determining, at the device, a detected gesture based on the sensor data. The method also includes obtaining, at the device, gesture configuration data associated with at least one user-assigned gesture and at least one operation, where the gesture configuration data maps each of the at least one user-assigned gesture to a respective operation of the at least one operation. The method also includes, based on the gesture configuration data indicating that the detected gesture matches one of the at least one user-assigned gesture, initiating a corresponding operation of the at least one operation.

According to another implementation of the present disclosure, a non-transitory computer-readable medium stores instructions that, when executed by one or more processors, cause the one or more processors to obtain sensor data from a sensor, where the sensor data indicates movement of a wearable device. The instructions cause the one or more processors to determine a detected gesture based on the sensor data. The instructions cause the one or more processors to obtain gesture configuration data associated with at least one user-assigned gesture and at least one operation, where the gesture configuration data maps each of the at least one user-assigned gesture to a respective operation of the at least one operation. The instructions cause the one or more processors to, based on the gesture configuration data indicating that the detected gesture matches one of the at least one user-assigned gesture, initiate a corresponding operation of the at least one operation.

According to one implementation of the present disclosure, an apparatus includes means for obtaining sensor data from a sensor, wherein the sensor data indicates movement of a wearable device. The apparatus includes means for determining a detected gesture based on the sensor data. The apparatus includes means for obtaining gesture configuration data associated with at least one user-assigned gesture and at least one operation, wherein the gesture configuration data maps each of the at least one user-assigned gesture to a respective operation of the at least one operation. The apparatus also includes means for initiating, based on the gesture configuration data indicating that the detected gesture matches one of the at least one user-assigned gesture, a corresponding operation of the at least one operation.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform configurable gesture-based operation control, in accordance with some examples of the present disclosure.

FIG. 2 is a block diagram of another illustrative aspect of a system operable to perform configurable gesture-based operation control, in accordance with some examples of the present disclosure.

FIG. 3 illustrates an example of an integrated circuit operable to perform configurable gesture-based operation control, in accordance with some examples of the present disclosure.

FIG. 4 is a diagram of a mobile device operable to perform configurable gesture-based operation control, in accordance with some examples of the present disclosure.

FIG. 5 is a diagram of a headset operable to perform configurable gesture-based operation control, in accordance with some examples of the present disclosure.

FIG. 6 is a diagram of a wearable electronic device operable to perform configurable gesture-based operation control, in accordance with some examples of the present disclosure.

FIG. 7 is a diagram of a mixed reality or augmented reality glasses device operable to perform configurable gesture-based operation control, in accordance with some examples of the present disclosure.

FIG. 8 is a diagram of earbuds operable to perform configurable gesture-based operation control, in accordance with some examples of the present disclosure.

FIG. 9 is a diagram of a voice-controlled speaker system operable to perform configurable gesture-based operation control, in accordance with some examples of the present disclosure.

FIG. 10 is a diagram of a camera operable to perform configurable gesture-based operation control, in accordance with some examples of the present disclosure.

FIG. 11 is a diagram of a headset, such as a virtual reality, mixed reality, or augmented reality headset, operable to perform configurable gesture-based operation control, in accordance with some examples of the present disclosure.

FIG. 12 is a diagram of a first example of a vehicle operable to perform configurable gesture-based operation control, in accordance with some examples of the present disclosure.

FIG. 13 is a diagram of a second example of a vehicle operable to perform configurable gesture-based operation control, in accordance with some examples of the present disclosure.

FIG. 14 is a diagram of a particular implementation of a method of performing configurable gesture-based operation control that may be performed by the system of FIG. 1 or FIG. 2, in accordance with some examples of the present disclosure.

FIG. 15 is a block diagram of a particular illustrative example of a device that is operable to perform configurable gesture-based operation control, in accordance with some examples of the present disclosure.

### V. DETAILED DESCRIPTION

There are often instances when hands-free operation control of an electronic device is more convenient. For example, a user may be cooking, painting, riding a bicycle, etc., when a voice call is received at a device. There is delay and inconvenience associated with the user having to stop what they are doing, possibly having to wipe their hands or perform another task, to provide user input to the device to answer the call. Although voice-command control technology can provide a user with a means for controlling some devices, in some cases, non-verbal operation control is more suitable. For example, a user may have a camera device set up to capture a moment that would be spoiled with a verbal command to take the picture.

Systems and methods of performing configurable gesture-based operation control are disclosed. For example, a gesture-based controller of a device includes a gesture detector and an operation selector. The gesture detector is coupled to a sensor that generates sensor data indicating movement of a wearable device (e.g., a headset) of a user. The gesture detector determines a detected gesture based on the sensor data. For example, the gesture detector, based on determining that the sensor data corresponds to a back-to-front head movement, determines that the detected gesture corresponds to a nod. The operation selector initiates a particular operation (e.g., answer a voice call) that corresponds to the detected gesture. The particular operation may be initiated at the device, the wearable device (e.g., the headset), another device, or a combination thereof.

In an example, gesture configuration data indicates at least one user-assigned operation and at least one operation. For example, the gesture configuration data may indicate that a first user-assigned gesture (e.g., a nod) corresponds to a call acceptance operation, and that a second user-assigned gesture (e.g., a head shake) corresponds to a call decline operation. The operation selector initiates a particular operation responsive to determining that the detected gesture matches the corresponding user-assigned operation. In this example, the operation selector accepts the call responsive to determining that the detected gesture corresponds to a nod. Alternatively, the operation selector may decline the call responsive to determining that the detected gesture corresponds to a head shake.

In some examples, the device includes a configurer that can train the gesture detector to detect a new gesture. For example, the configurer can train the gesture detector to detect a head tilt (e.g., a sideways head movement). In some examples, the configurer can update the gesture configuration data to update associations between user-assigned gestures and respective operations. To illustrate, the configurer can update the gesture configuration data to change an operation that is assigned to a user-assigned gesture, change a user-assigned gesture that is assigned to an operation, add an association between a user-assigned gesture (e.g., head tilt) and a corresponding operation (e.g., skip to next song in playlist), or a combination thereof.

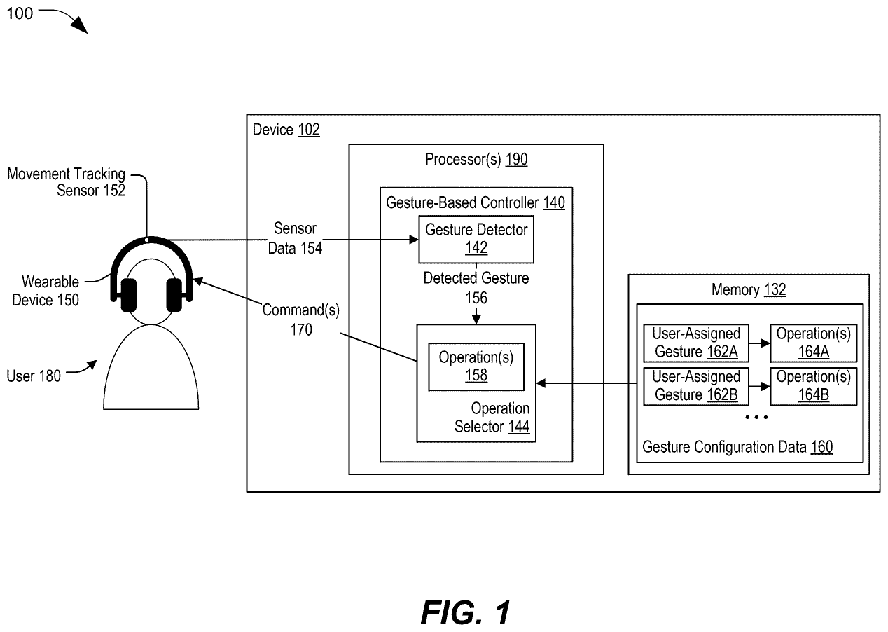

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple user-assigned gestures are illustrated and associated with reference numbers 162A and 162B. When referring to a particular one of these user-assigned gestures, such as a user-assigned gesture 162A, the distinguishing letter “A” is used. However, when referring to any arbitrary one of these user-assigned gestures or to these user-assigned gestures as a group, the reference number 162 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1, a particular illustrative aspect of a system configured to perform configurable gesture-based operation control is disclosed and generally designated 100. The system 100 includes a device 102 that is coupled to a wearable device 150.

Movement of the wearable device 150 can be used to estimate head movement of a user 180 (e.g., a back-to-front head movement) who is wearing the wearable device 150 and the estimated head movement can be identified as corresponding to a detected gesture 156 (e.g., a nod). The wearable device 150 is depicted as a headset in FIG. 1 as an illustrative example; in other examples the wearable device 150 can include various types of devices such as an earbud, glasses, etc. It should be understood that the wearable device 150 being worn on a head of the user 180, and movement of the wearable device 150 corresponding to a head movement used to determine the detected gesture 156, is provided as an illustrative example; in other examples, the wearable device 150 may be worn on other parts of the user 180 such as their hand, arm, leg, etc., and movement of the wearable device 150 can correspond to various types of movements (e.g., a hand movement, a finger movement, a foot movement, an arm movement, a face movement, an eye movement, or a combination thereof) that can be used to determine the detected gesture 156.

The device 102 includes one or more processors 190 coupled to a memory 132. Although the device 102 is illustrated in FIG. 1 as being separate from the wearable device 150, in some other embodiments, the wearable device 150 and the device 102 are the same device. To illustrate, in these embodiments, the one or more processors 190, the memory 132, or both, are integrated into the wearable device 150. The one or more processors 190 include a gesture-based controller 140 that includes a gesture detector 142 coupled to an operation selector 144, as further described below.

The memory 132 is configured to store gesture configuration data 160 associated with at least one user-assigned gesture 162 and at least one operation 164. For example, the gesture configuration data 160 maps each of the at least one user-assigned gesture 162 to a respective operation of the at least one operation 164. To illustrate, the gesture configuration data 160 indicates that a user-assigned gesture 162A corresponds to one or more operations 164A, a user-assigned gesture 162B corresponds to one or more operations 164B, and so on. In an example, a user-assigned gesture 162 can correspond to a head movement, such as a nod, a head tilt, a clockwise head rotation, an anti-clockwise head rotation, a head shake, a head turn, head bobbing, a chin jut, a head drop, a head raise, a head jerk back, or a combination thereof. In some examples, a user-assigned gesture 162 can correspond to various types of movements, such as a head movement, a hand movement, a finger movement, a foot movement, an arm movement, a face movement, an eye movement, or a combination thereof.

In some examples, multiple user-assigned gestures 162 can correspond to the same operation 164. To illustrate, either a head tilt or a nod can be used to initiate the same operation if the gesture configuration data 160 indicates that both gestures are associated with the operation. In some examples, the memory 132 includes multiple sets of gesture configuration data 160 associated with multiple applications. To illustrate, a first set of gesture configuration data 160 is associated with a first application (e.g., a media playback application), and a second set of gesture configuration data 160 is associated with a second application (e.g., a navigation application). In some of these examples, the same user-assigned gesture 162 can correspond to one operation 164 in the first set of gesture configuration data 160 and can correspond to another operation 164 in the second set of gesture configuration data 160. To illustrate, a nod can correspond to a “initiate media playback” operation in the first set of gesture configuration data 160 associated with the media playback application, and a nod can correspond to an “initiate navigation” operation in the second set of gesture configuration data 160 associated with the navigation application.

In some examples, one user-assigned gesture 162 can correspond to a particular operation 164 in the first set of gesture configuration data 160 and another user-assigned gesture 162 can correspond to the same operation 164 in the second set of gesture configuration data 160. To illustrate, a right-head tilt can correspond to an “increase volume” operation in the first set of gesture configuration data 160 associated with the media playback application, and a clock wise head rotation can correspond to the “increase volume” operation in the second set of gesture configuration data 160 associated with the navigation application.

It should be understood that a set of gesture configuration data 160 associated with an application is provided as an illustrative example; in some examples a set of gesture configuration data 160 can be associated with various attributes, such as an application, a device condition, a device location, a wearable device location, a user role, a user account, or a combination thereof. In some aspects, one or more attributes of a set of gesture configuration data 160 are based on a configuration setting, a user input, default data, or a combination thereof.

In some embodiments, a movement tracking sensor 152 is integrated into the wearable device 150, as depicted in FIG. 1. Optionally, in other embodiments, the movement tracking sensor 152 (e.g., a camera) is external to the wearable device 150. In some examples, the movement tracking sensor 152 is integrated into the device 102. In some examples, the movement tracking sensor 152 is external to the wearable device 150, external to the device 102, or both. In some aspects, the movement tracking sensor 152 includes at least one of an accelerometer, a gyroscope, a magnetometer, an inertial measurement unit (IMU), an optical sensor, a proximity sensor, a camera, an ultrasonic sensor, a light detection and ranging (LIDAR) sensor, a radio frequency identification (RFID) sensor, a radar sensor, or a motion-capture system. The movement tracking sensor 152 is configured to track movement of the wearable device 150. For example, the movement tracking sensor 152 is configured to generate sensor data 154 indicating movement of the wearable device 150.

In some examples, the one or more processors 190 of the device 102 are configured to receive the sensor data 154, via an interface or a modem of the device 102, from the wearable device 150. The gesture detector 142 is configured to obtain the sensor data 154 from the movement tracking sensor 152 and to process the sensor data 154 to determine a detected gesture 156. Optionally, in some embodiments, the gesture detector 142 includes a machine learning (ML) model (e.g., a neural network) configured to process the sensor data 154 to determine the detected gesture 156. The gesture detector 142 is configured to output an indicator of the detected gesture 156 to the operation selector 144.

The operation selector 144 is configured to select one or more operations 158 that correspond to the detected gesture 156 based on a comparison of the detected gesture 156 and the one or more user-assigned gestures 162 indicated in the gesture configuration data 160. As an example, the operation selector 144 is configured to obtain a first indicator of a detected gesture 156 from the gesture detector 142 and determine whether the detected gesture 156 matches any of the at least one user-assigned gesture 162. In some examples, the operation selector 144 is configured to, based on determining that the first indicator is the same as (e.g., equal to) a second indicator of a user-assigned gesture 162A in the gesture configuration data 160, determine that the detected gesture 156 matches the user-assigned gesture 162A. In some other examples, the operation selector 144 is configured to determine a similarity metric based on a comparison of the first indicator and the second indicator and, based on determining that the similarity metric satisfies a similarity threshold, determine that the detected gesture 156 matches the user-assigned gesture 162A. In an illustrative example, the first indicator corresponds to a first feature vector in a gesture feature space, the second indicator corresponds to a second feature vector in the gesture feature space, and the similarity metric corresponds to a vector difference between the first feature vector and the second feature vector. The operation selector 144 is configured to, based on determining that the detected gesture 156 matches the user-assigned gesture 162A and that the gesture configuration data 160 indicates that the user-assigned gesture 162A is associated with the one or more operations 164A, select the one or more operations 164A as the one or more operations 158.

The operation selector 144 is configured to initiate the one or more operations 158 (e.g., the one or more operations 164A). In an example, the operation selector 144 is configured to initiate at least one of the one or more operations 158 at the device 102 (e.g., the one or more processors 190). In an example, the operation selector 144 is configured to send one or more commands 170 to the wearable device 150 to initiate at least one of the one or more operations 158 at the wearable device 150. In an example, the operation selector 144 of the device 102 (e.g., a phone) is configured to send one or more commands 170 to another device (e.g., a network device, a camera, a vehicle, etc.) to initiate at least one of the one or more operations 158 at the other device.

In an illustrative example, the operation selector 144 is configured to determine, based on whether the detected gesture 156 matches a nod (e.g., the user-assigned gesture 162A) or a head tilt (e.g., the user-assigned gesture 162B), whether to initiate performance of the one or more operations 164A or the one or more operations 164B. In another illustrative example, the operation selector 144 is configured to determine, based on whether the detected gesture 156 matches a clockwise head rotation (e.g., the user-assigned gesture 162A) or an anti-clockwise head rotation (e.g., the user-assigned gesture 162B), whether to initiate performance of the one or more operations 164A or the one or more operations 164B.

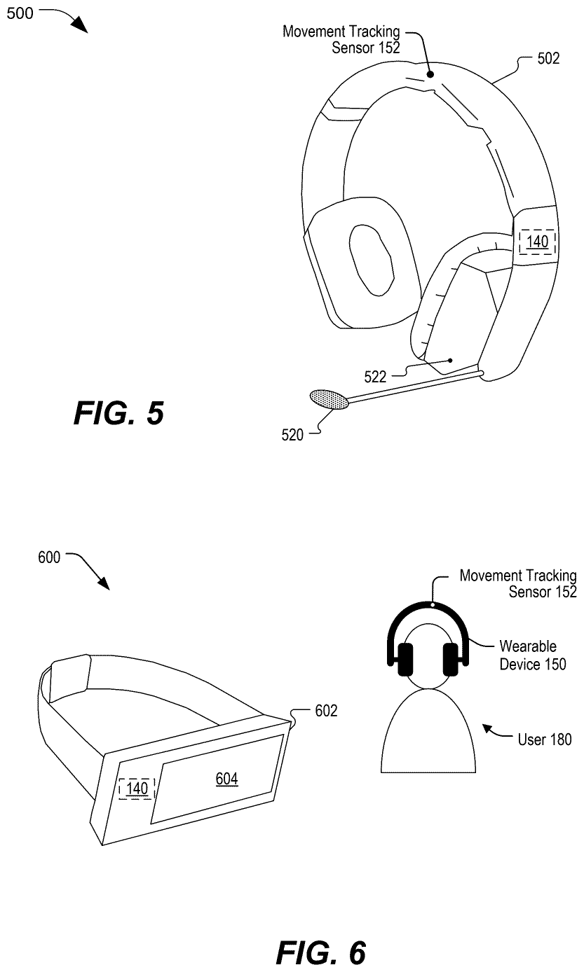

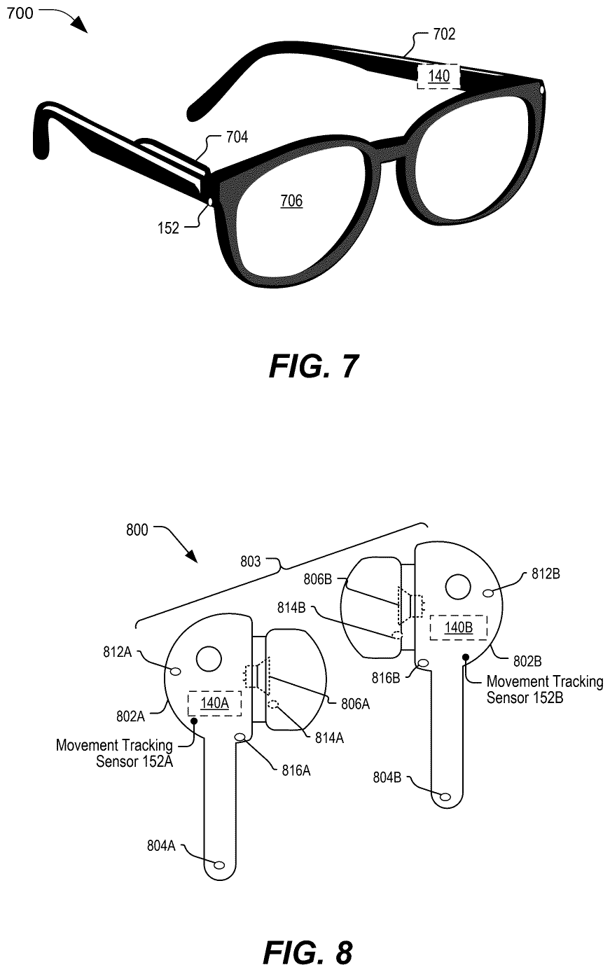

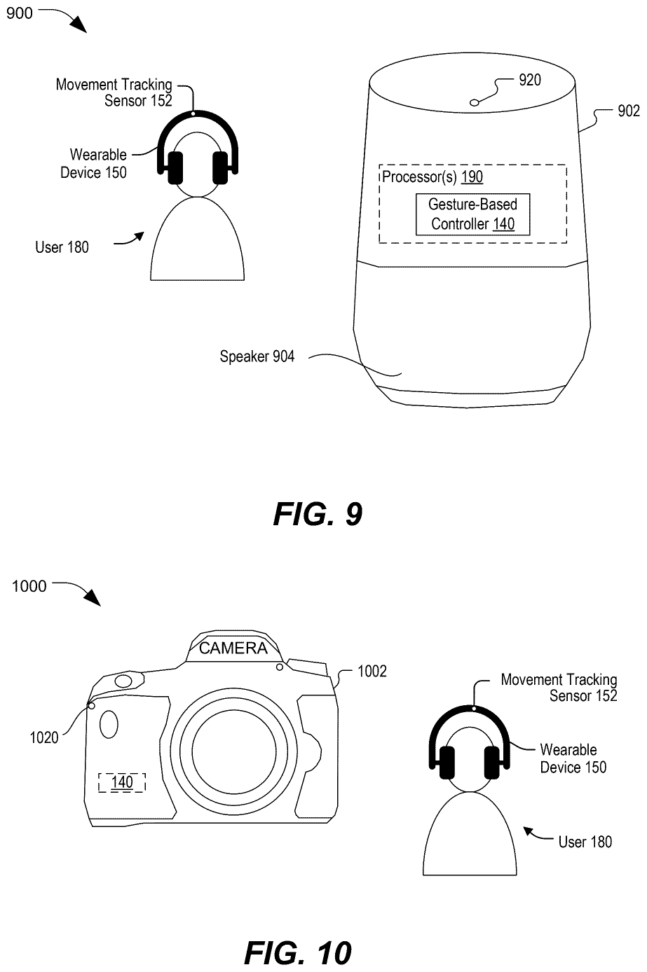

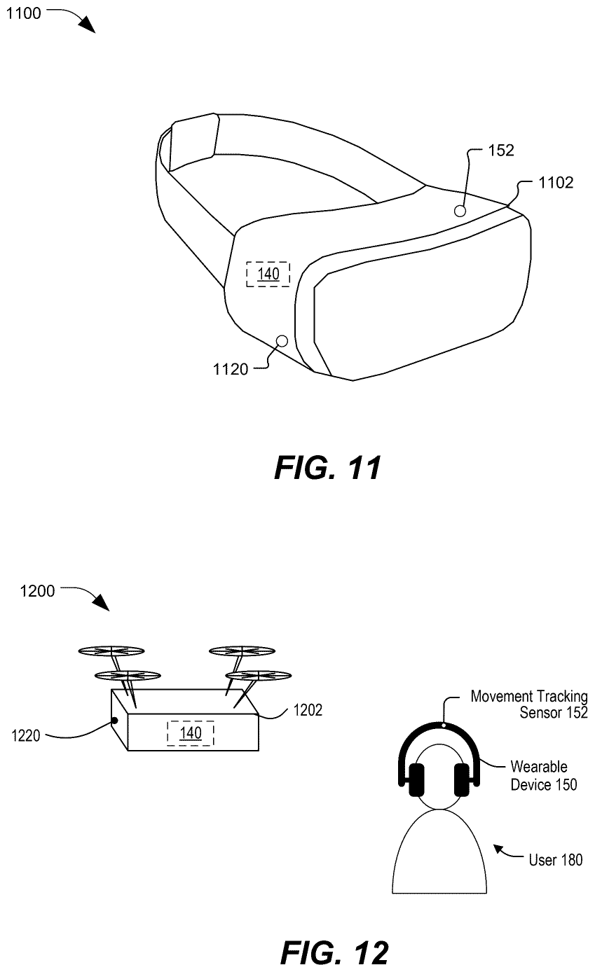

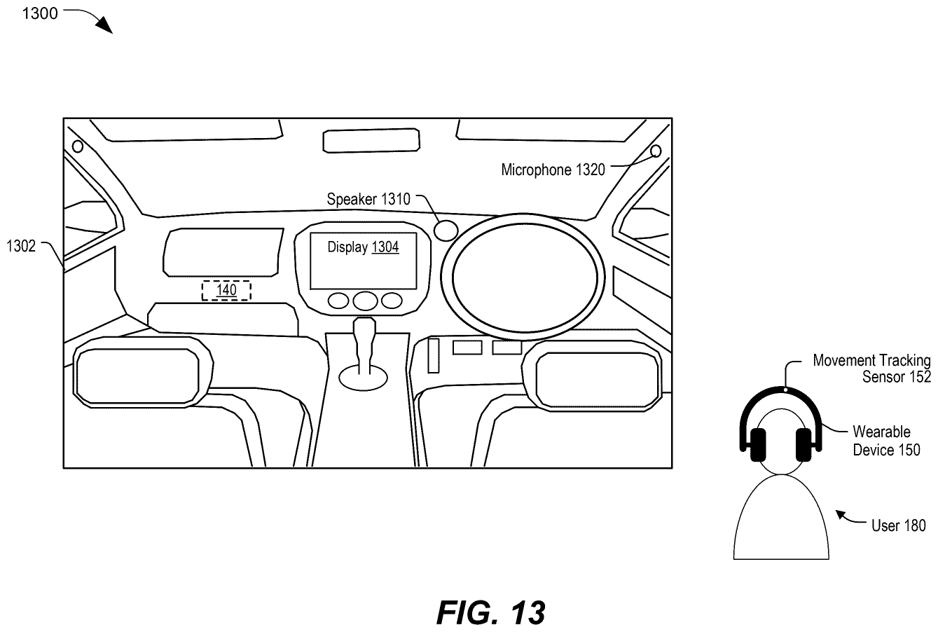

In some embodiments, the device 102 corresponds to or is included in one of various types of devices. In an illustrative example, the one or more processors 190 are integrated into a headset device, such as described further with reference to FIG. 5. In other examples, the one or more processors 190 are integrated into at least one of a mobile phone or a tablet computer device, as described with reference to FIG. 4, a wearable electronic device, as described with reference to FIG. 6, a mixed reality or augmented reality glasses device, as described with reference to FIG. 7, earbuds, as described with reference to FIG. 8, a voice-controlled speaker system, as described with reference to FIG. 9, a camera device, as described with reference to FIG. 10, or a virtual reality, mixed reality, or augmented reality headset, as described with reference to FIG. 11. In another illustrative example, the one or more processors 190 are integrated into a vehicle, such as described further with reference to FIG. 12 and FIG. 13.

During operation, the movement tracking sensor 152 generates sensor data 154 indicating movement of the wearable device 150. In an example, a user 180 is wearing the wearable device 150 while the movement tracking sensor 152 is tracking the movement of the wearable device 150. In a particular aspect, the sensor data 154 indicates yaw, pitch, roll, or a combination thereof, of the wearable device 150 at various sampling times or according to various sampling frequencies.

In some examples, the sensor data 154 generated by the movement tracking sensor 152 is used to perform other operations at the device 102 and no additional sensors are used for the gesture-based controller 140. To illustrate, the one or more processors 190 use the sensor data 154 from the movement tracking sensor 152 to perform beamforming to generate spatial audio output and provide the spatial audio output to the wearable device 150. The sensor data 154 from the movement tracking sensor 152 used to perform beamforming can also be used to detect gestures. Hence, the gesture-based controller 140 can be implemented without any additional cost of specialized sensors having to be added to a wearable device 150, and the gesture-based controller 140 can operate in conjunction with a variety of wearable devices 150.

The gesture detector 142 processes the sensor data 154 to determine a detected gesture 156 and provides an indicator of the detected gesture 156 to the operation selector 144. In some embodiments, the gesture detector 142 selectively processes the sensor data 154 based on determining that one or more gesture detection criteria are satisfied. For example, the gesture detector 142 determines that a first gesture detection criterion is satisfied based on determining that the wearable device 150 is being worn by the user 180. To illustrate, the gesture detector 142 determines that the wearable device 150 is being worn based on sensor data from a proximity sensor of the wearable device 150 indicating that the wearable device 150 is being worn. In another example, the gesture detector 142 determines that a second gesture detection criterion is satisfied based on determining that at least one application that implements gesture-based control is activated. In yet another example, the gesture detector 142 determines that a third gesture detection criterion is satisfied based on determining that the device 102 has a particular device condition (e.g., greater than threshold remaining battery, lower than threshold memory usage, lower than threshold processor usage, lower than threshold temperature, or a combination thereof) associated with gesture-based control. The gesture detector 142, based on determining that the first gesture detection criterion, the second gesture detection criterion, the third gesture detection criterion, one or more additional gesture detection criteria, or a combination thereof, are satisfied, processes the sensor data 154 to determine the detected gesture 156 and provides an indicator of the detected gesture 156 to the operation selector 144. In some aspects, the one or more gesture detection criteria are based on a configuration setting, a user input, default data, or a combination thereof.

In some embodiments, the operation selector 144 selects a set of gesture configuration data 160 from a plurality of sets of gesture configuration data. In a particular aspect, the operation selector 144 selects a set of gesture configuration data 160 in response to determining that one or more attributes associated with the set of configuration data 160 are detected. For example, the gesture detector 142 can determine that an attribute of a set of gesture configuration data 160 is detected based on determining that a corresponding application is activated. As an illustrative example, a first set of the gesture configuration data 160 is associated with a communication application that supports a calling feature and the operation selector 144, in response to detecting that a call is being received, determines that an attribute of the first set of gesture configuration data 160 is detected. As another example, a second set of the gesture configuration data 160 is associated with a media playback application and the gesture detector 142, in response to detecting that the media playback application is open, determines that an attribute of the second set of gesture configuration data 160 is detected.

In some examples, the gesture detector 142 determines that an attribute of a set of gesture configuration data 160 is detected based on determining that the set of gesture configuration data 160 is associated with a particular device condition that matches a detected device condition of the device 102 (e.g., greater than threshold remaining battery, lower than threshold memory usage, lower than threshold processor usage, lower than threshold temperature, or a combination thereof). To illustrate, a first set of operations 164 (e.g., a system update) is to be performed when the device 102 is charging and not when the device 102 is unplugged. A set of gesture configuration data 160 that is associated with the first set of operations 164 is associated with a particular device charging mode, and the gesture detector 142 determines that an attribute of the set of gesture configuration data 160 is detected when a charging mode of the device 102 matches the particular device charging mode.

In some examples, the gesture detector 142 determines that an attribute of a set of gesture configuration data 160 is detected based on determining that a device location of the device 102, a wearable device location of the wearable device 150, a user role of the user 180, a user account of the user 180, or a combination thereof, are associated with access to gesture-based control, match a corresponding attribute of the set of gesture configuration data 160, or both.

After selecting the appropriate gesture configuration data 160, the operation selector 144 determines whether the detected gesture 156 matches any of the one or more user-assigned gestures 162 of the gesture configuration data 160 (e.g., a selected set of gesture configuration data 160). The operation selector 144, based on determining that the detected gesture 156 matches a user-assigned gesture 162 of the gesture configuration data 160, initiates corresponding one or more operations 164. For example, the operation selector 144, based on determining that the detected gesture 156 matches the user-assigned gesture 162A of the gesture configuration data 160 and that the gesture configuration data 160 indicates that the user-assigned gesture 162A corresponds to the one or more operations 164A, selects the one or more operations 164A as one or more operations 158 and initiates the one or more operations 158, as further described with reference to FIGS. 4-13.

In an example, the operation selector 144 initiates at least one first operation of the one or more operations 158 at the device 102 (e.g., the one or more processors 190), initiates at least one second operation of the one or more operations 158 at the wearable device 150, initiates at least one third operation of the one or more operations 158 at another device, or a combination thereof. To illustrate initiation of operations at other devices, the operation selector 144 sends one or more commands 170 to the wearable device 150 to initiate the at least one second operation at the wearable device 150, sends one or more commands to another device to initiate the at least one third operation at the other device, or a combination thereof. As an illustrative example, the one or more operations 158 may correspond to call acceptance operations. In this example, the operation selector 144 can initiate call acceptance at the device 102 and send, to the wearable device 150, a first command 170 and a first audio signal that corresponds to incoming audio of the call. The wearable device 150, in response to receiving the first command 170, can initiate output of the first audio signal via a speaker of the wearable device 150 and initiate sending of a second audio signal from a microphone of the wearable device 150 to the device 102 that corresponds to speech of the user 180, ambient noise, or both. In some examples, the operation selector 144 can, concurrently with initiating call acceptance at the device 102, send a second command 170 to another device. To illustrate, the other device can include a media device that pauses media playback responsive to the second command 170.

Optionally, in some embodiments, the gesture detector 142 determines that the sensor data 154 likely corresponds to any of a plurality of detected gestures 156 and generates respective confidence values. For example, the gesture detector 142 generates data indicating that the sensor data 154 could correspond to a first detected gesture 156 (e.g., a head shake) with a first confidence value (e.g., 0.7), a second detected gesture 156 (e.g., a head tilt) with a second confidence value (e.g., 0.6), and so on.

In some aspects, the operation selector 144 identifies a set of matching detected gestures 156 from the plurality of detected gestures 156 that match any of the one or more user-assigned gestures 162 of the gesture configuration data 160 (e.g., the selected set of gesture configuration data 160). As an example, the operation selector 144 determines a set of similarity metrics associated with each detected gesture 156 and the one or more user-assigned gestures 162, uses the set of similarity metrics to identify a user-assigned gesture 162 (if any) that most closely matches the detected gesture 156, and, if the most closely matching user-assigned gesture 162 is sufficiently similar, the operation selector 144 adds the detected gesture 156 to the set of matching detected gestures 156 with an indication of the identified most closely matching user-assigned gesture 162. To illustrate, the operation selector 144 determines a set of similarity metrics associated with a first detected gesture 156 and the one or more user-assigned gestures 162. The set of similarity metrics includes a first similarity metric based on a comparison of an indicator of the first detected gesture 156 and an indicator of a user-assigned gesture 162A, a second similarity metric based on a comparison of the indicator of the first detected gesture 156 and an indicator of a user-assigned gesture 162B, and so on. The operation selector 144 selects a similarity metric that indicates the closest match from the set of similarity metrics. For example, the operation selector 144 selects the first similarity metric having the highest value among the set of similarity metrics and determines that the user-assigned gesture 162A corresponding to the first similarity metric is the closest matching user-select gesture of the detected gesture 156. The operation selector 144, based on determining that the first similarity metric satisfies one or more similarity thresholds, adds the first detected gesture 156 to the set of matching detected gestures 156 with an indication that the first detected gesture 156 is a most close match of the user-assigned gesture 162A.

The operation selector 144 selects a detected gesture 156 from among the set of matching detected gestures 156 based on determining that a confidence value of the detected gesture 156 satisfies a confidence value criterion (e.g., highest confidence value, confidence value that satisfies one or more thresholds, or a combination thereof). For example, the operation selector 144 selects a detected gesture 156 having the highest confidence value among the set of matching detected gestures 156. The operation selector 144 initiates the one or more operations 164 associated with the user-assigned gesture 162 that is a most close match of the selected detected gesture 156.

In a first example, the operation selector 144, based on determining that the first detected gesture 156 (e.g., a head shake) is most close match of the user-assigned gesture 162A, adds the first detected gesture 156 to a set of matching detected gestures 156. Similarly, the operation selector 144, based on determining that the second detected gesture 156 (e.g., a head tilt) is a most close match of the user-assigned gesture 162B, adds the second detected gesture 156 to the set of matching detected gestures 156. The operation selector 144, based on determining that the first detected gesture 156 (e.g., a head shake) has the highest confidence value (e.g., 0.7) among the set of matching detected gestures 156, initiates the one or more operations 164A (e.g., as the one or more operations 158) associated with the user-assigned gesture 162A that is a most close match of the first detected gesture 156 (e.g., a head shake).

In a second example, the operation selector 144, based on determining that the first detected gesture 156 (e.g., a head shake) does not match any of the one or more user-assigned gestures 162 of the gesture configuration data 160, refrains from adding the first detected gesture 156 to the set of matching detected gestures 156. The operation selector 144, based on determining that the second detected gesture 156 (e.g., a head tilt) is a most close match of the user-assigned gesture 162B, adds the second detected gesture 156 to the set of matching detected gestures 156. The operation selector 144, based on determining that the second detected gesture 156 (e.g., a head tilt) has the highest confidence value (e.g., 0.6) among the set of matching detected gestures 156, initiates the one or more operations 164B (e.g., as the one or more operations 158) associated with the user-assigned gesture 162B that is a most close match of the second detected gesture 156.

The gesture detector 142 processing the sensor data 154 to determine the detected gesture 156 independently of the gesture configuration data 160 is provided as an illustrative example; in some other examples the gesture detector 142 processes the sensor data 154 to determine whether any of the one or more user-assigned gestures 162 of the gesture configuration data 160 (e.g., a selected set of the gesture configuration data 160) are detected. For example, the gesture detector 142 outputs a first value (e.g., 0) indicating that the sensor data 154 does not correspond to any of the one or more user-assigned gestures 162. Alternatively, the gesture detector 142 outputs an indicator of a user-assigned gesture 162 as the detected gesture 156 that corresponds to the sensor data 154. The gesture detector 142 can thus be trained to detect each of the one or more user-assigned gestures 162 of the gesture configuration data 160 and disregard other gestures. The gesture detector 142 so trained may be faster and smaller, as compared to a gesture detector that can distinguish between various additional gestures that are not included in the gesture configuration data 160. The operation selector 144 initiates one or more operations 164 (e.g., as the one or more operations 158) that are indicated by the gesture configuration data 160 as corresponding to the user-assigned gesture 162 (e.g., the detected gesture 156).

A technical advantage of the system 100 thus includes providing the user 180 with non-verbal and hands-free operation control of one or more applications while wearing the wearable device 150. To illustrate, the user 180 can use gestures (e.g., head movements) to control operations at the device 102, the wearable device 150, another device, or a combination thereof. For example, the user 180 can answer a voice call without having to stop doing something else and/or without waiting for a delay associated with completing a current task that prevents them from interacting with the device 102. To illustrate, the user 180 can answer the voice call while driving without having to take eyes off the road or hands off the steering wheel. As another example, the user 180 can quietly use a gesture to trigger a camera without spoiling a moment with a verbal command.

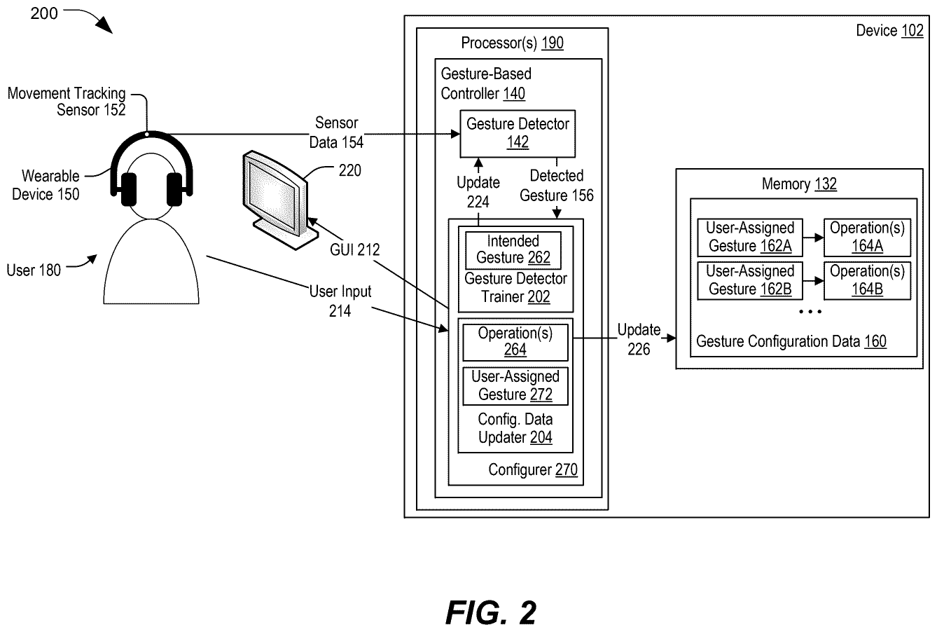

Referring to FIG. 2, a particular illustrative aspect a system configured to perform configurable gesture-based operation control is disclosed and generally designated 200. The system 200 enables training of the gesture detector 142 to detect a new gesture, update the gesture configuration data 160, or both. In a particular aspect, the system 100 of FIG. 1 includes one or more components of the system 200.

Optionally, in some embodiments, the device 102 is coupled to a display device 220. The display device 220 is depicted as external to the device 102 and external to the wearable device 150 as an illustrative example; in other examples the display device 220 can be integrated into the device 102, the wearable device 150, or both. The gesture-based controller 140 includes a configurer 270 coupled to the gesture detector 142, the memory 132, or both. The configurer 270 includes a gesture detector trainer 202, a configuration data updater 204, or both. The gesture detector trainer 202 is configured to train the gesture detector 142 to detect new gestures. The configuration data updater 204 is configured to update the gesture configuration data 160.

During a configuration phase, the user 180 initiates training of the gesture detector 142 to detect a new gesture. In some examples, the user 180 initiates the configuration phase based on determining that a detected gesture 156 determined by the gesture detector 142 does not match an intended gesture 262 of the user 180. In an example, the user 180 performs an intended gesture 262 while wearing the wearable device 150, and the gesture detector 142 receives the sensor data 154 from the movement tracking sensor 152 indicating movement of the wearable device 150. The gesture detector 142 processes the sensor data 154 to generate an indicator of a detected gesture 156. The configurer 270 generates a GUI 212 including the indicator (e.g., text, feature values, etc.) of the detected gesture 156 output by the gesture detector 142. The configurer 270 provides the GUI 212 to the display device 220.

The user 180 provides a user input 214 via the GUI 212 to the configurer 270 including an indicator (e.g., text, feature values, etc.) of the intended gesture 262 (e.g., a head tilt). In some embodiments, the user 180 provides the user input 214 concurrently with performing the intended gesture 262, subsequent to the gesture detector 142 determining the detected gesture 156, or both. To illustrate, the user 180 can select an input option of the GUI 212 that corresponds to the intended gesture 262, enter the indicator of the intended gesture 262 via keyboard input, verbally provide the indicator of the intended gesture 262 via a microphone, or a combination thereof, as the user input 214. In some examples, the gesture detector trainer 202 outputs the indicator of the detected gesture 156 via the GUI 212 and the user 180 provides a user input 214 (e.g., yes or no) to the configurer 270 indicating whether the detected gesture 156 matches the intended gesture 262. To illustrate, the user input 214 can correspond to a similarity value (e.g., between 1 and 5) provided by the user 180 that indicates how closely the detected gesture 156 matches the intended gesture 262.

In a particular aspect, the gesture detector trainer 202 selectively updates the gesture detector 142 (e.g., the ML model) based on determining whether the detected gesture 156 matches the intended gesture 262. For example, the gesture detector trainer 202, in response to determining that the user input 214 indicates the detected gesture 156 matches the intended gesture 262, determines that the gesture detector 142 is configured to detect the intended gesture 262 and refrains from updating the gesture detector 142. Alternatively, the gesture detector trainer 202, in response to determining that the user input 214 indicates that the detected gesture 156 does not match the intended gesture 262, provides an update 224 to the gesture detector 142. In an example, the update 224 includes the indicator of the intended gesture 262 and the gesture detector trainer 202 applies the update 224 to the gesture detector 142 to associate the sensor data 154 (corresponding to the detected gesture 156) with the intended gesture 262. In some embodiments, the gesture detector 142 includes an ML model (e.g., a neural network) and the gesture detector trainer 202 applies the update 224 to adjust model parameters (e.g., weights, biases, or both) of the ML model based on a comparison of (e.g., a difference between) the indicator of the detected gesture 156 and the indicator of the intended gesture 262. To illustrate, in an example, the user 180 provides the user input 214 including a similarity value that indicates how closely the detected gesture 156 matches the intended gesture 262 and the gesture detector trainer 202 generates the update 224 based on the similarity value.

In some examples, the gesture detector trainer 202 iteratively trains the gesture detector 142 to detect the intended gesture 262. To illustrate, after the update 224 is applied to the gesture detector 142 in a first iteration, the gesture detector 142 processes the sensor data 154 to generate an indicator of the detected gesture 156 and increments an iteration count. The gesture detector trainer 202, based on determining that the detected gesture 156 does not match the intended gesture 262 and that the iteration count is less than an iteration threshold, applies another update 224 to the gesture detector 142 in a subsequent iteration, processes the sensor data 154 to generate an indicator of the detected gesture 156, and increments the iteration count. The processing continues until the gesture detector 142 is trained to detect the intended gesture 262 or the iteration count is reached. In some examples, the user 180 performs the intended gesture 262 multiple times to generate multiple sets of sensor data 154 so that the gesture detector trainer 202 can train the gesture detector 142 to detect the intended gesture 262 including variations in performance of the intended gesture 262 by the user 180.

In a particular aspect, the configuration data updater 204 selectively updates the gesture configuration data 160 based on a user input 214. For example, the user 180 provides a user input 214 indicating that a user-assigned gesture 272 is to be associated with one or more operations 264. In some examples, the user input 214 indicates that the user-assigned gesture 272 includes the detected gesture 156 and is to be associated with one or more operations 264.

In some aspects, the user-assigned gesture 272 corresponds to a new gesture to be added to the gesture configuration data 160. For example, the configuration data updater 204, based on determining that the user-assigned gesture 272 does not match any of the one or more user-assigned gestures 162 of the gesture configuration data 160, performs an update 226 of the gesture configuration data 160 to add an association between the user-assigned gesture 272 (e.g., a new user-assigned gesture 162) and the one or more operations 264.

In some aspects, the user-assigned gesture 272 corresponds to an existing gesture of the gesture configuration data 160 that is to be associated with the one or more operations 264. For example, the configuration data updater 204, in response to determining that the user-assigned gesture 272 matches a user-assigned gesture 162A of the gesture configuration data 160, performs an update 226 of the gesture configuration data 160 to indicate that the user-assigned gesture 162A is associated with the one or more operations 264. In some examples, the configuration data updater 204, based on determining that the user input 214 indicates that the one or more operations 264 are to be added to the user-assigned gesture 272, associates the user-assigned gesture 162A with the one or more operations 264 in addition to the one or more operations 164A. In some other examples, the configuration data updater 204, based on determining that the user input 214 indicates that the user-assigned gesture 272 is to be associated only with the one or more operations 264, associates the user-assigned gesture 162A with the one or more operations 264 as a replacement of the one or more operations 164A.

A technical advantage of the system 200 thus includes enabling the user 180 to update the gesture configuration data 160 to personalize the gesture-based controller 140 with new or updated gestures and/or operations. For example, the user 180 can use the gesture detector trainer 202 to train the gesture detector 142 to detect user-assigned gestures, update the gesture configuration data 160 to associate user-assigned gestures with user-assigned operations, or a combination thereof.

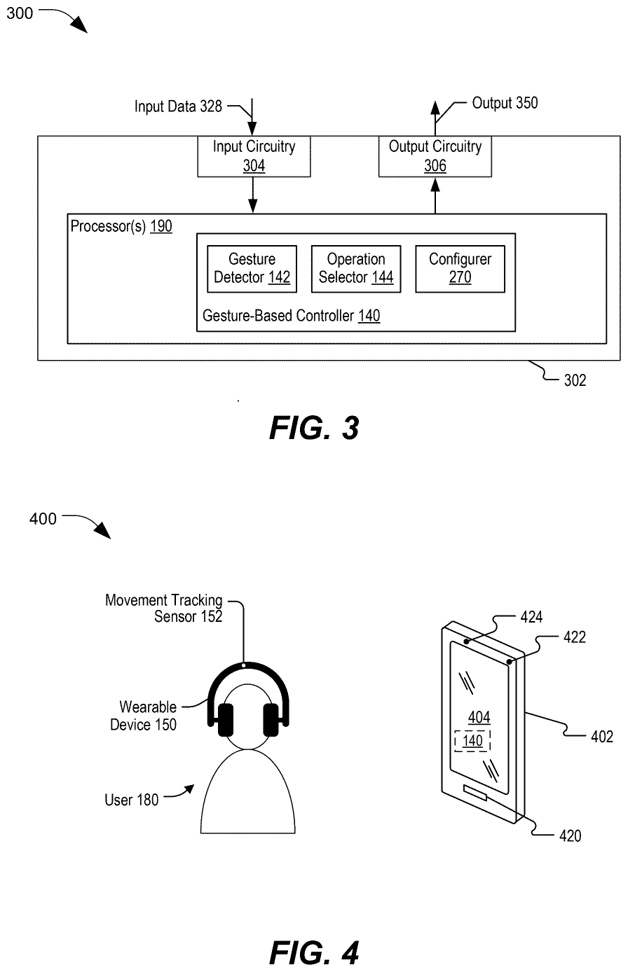

FIG. 3 depicts an implementation 300 of the device 102 as an integrated circuit 302 that includes the one or more processors 190, which include the gesture-based controller 140. The integrated circuit 302 also includes input circuitry 304, such as one or more bus interfaces, to enable input data 328 to be received for processing. In a particular aspect, the input data 328 includes data used by one or more components of the gesture-based controller 140, such as the sensor data 154, the indicator of the detected gesture 156, the gesture configuration data 160 of FIG. 1, the user input 214, the update 224 of FIG. 2, or a combination thereof.

The integrated circuit 302 also includes output circuitry 306, such as a bus interface, to enable sending of an output signal 350. In a particular aspect, the output signal 350 is generated by one or more components of the gesture-based controller 140, such as an indicator of the detected gesture 156, the one or more commands 170, the gesture configuration data 160 of FIG. 1, the update 224, the update 226, the GUI 212 of FIG. 2, or a combination thereof.

The integrated circuit 302 enables implementation of configurable gesture-based operation control as a component in a system, such as a mobile phone or tablet as depicted in FIG. 4, a headset as depicted in FIG. 5, a wearable electronic device as depicted in FIG. 6, a mixed reality or augmented reality glasses device, as described with reference to FIG. 7, earbuds, as described with reference to FIG. 8, a voice-controlled speaker system as depicted in FIG. 9, a camera as depicted in FIG. 10, a virtual reality, mixed reality, or augmented reality headset as depicted in FIG. 11, or a vehicle as depicted in FIG. 12 or FIG. 13.

FIG. 4 depicts an implementation 400 in which the device 102 includes a mobile device 402, such as a phone or tablet, as illustrative, non-limiting examples. The mobile device 402 includes a microphone 420, a speaker 422, a camera 424, and a display screen 404. Components of the one or more processors 190, including the gesture-based controller 140, are integrated into the mobile device 402 and are illustrated using dashed lines to indicate internal components that are not generally visible to a user of the mobile device 402.

In a particular example, the gesture detector 142 of the gesture-based controller 140 receives the sensor data 154 of FIG. 1 indicating movement of a wearable device 150. The wearable device 150 is depicted as a headset in FIG. 4 as an illustrative example, in other examples the wearable device 150 can include any type of wearable device, such as an earbud, a head-mounted display, computerized glasses, or the like. In some aspects, the gesture-based controller 140 receives first sensor data 154 from a movement tracking sensor 152 integrated into the wearable device 150, second sensor data 154 from the camera 424, or both. To illustrate, the camera 424 can correspond to a movement tracking sensor 152 alternatively or in addition to the movement tracking sensor 152 integrated into the wearable device 150. The gesture detector 142 processes the sensor data 154 to determine one or more detected gestures 156, as described with reference to FIG. 1.

The operation selector 144, based on the one or more detected gestures 156, initiates one or more operations 164, such as to launch a graphical user interface or otherwise display other information associated with a detected gesture 156 at the display screen 404 (e.g., via an integrated “smart assistant” application). In some aspects, the operation selector 144 initiates one or more operations 164 at the mobile device 402, the wearable device 150, another device, or a combination thereof.

In a voice call example, the operation selector 144 detects that a voice call is being received at the device 102 (e.g., the mobile device 402). The operation selector 144 determines, based on whether the detected gesture 156 matches a user-assigned gesture 162A (e.g., a first head movement) or a user-assigned gesture 162B (e.g., a second head movement), whether to accept or decline the voice call. To illustrate, the gesture configuration data 160 indicates that the user-assigned gesture 162A (e.g., a nod) corresponds to one or more operations 164A (e.g., a call acceptance operation), and the user-assigned gesture 162B (e.g., a head tilt) corresponds to one or more operations 164B (e.g., a call decline operation).

In an audio playback example, the one or more operations 164 can include shuffling a playlist, switching a music genre, adding a song to the playlist, transitioning to another song in the playlist, changing a selected language, or a combination thereof. For example, the gesture configuration data 160 indicates that a first user-assigned gesture 162A maps to one or more first operations 164A (e.g., shuffling a playlist), a second user-assigned gesture 162B maps to one or more second operations 164B (e.g., switching a music genre), a third user-assigned gesture 162 maps to one or more third operations 164 (e.g., adding a song to the playlist), a fourth user-assigned gesture 162 maps to one or more fourth operations 164 (e.g., transitioning to another song in the playlist), a fifth user-assigned gesture 162 maps to one or more fifth operations 164 (e.g., changing a selected language), or a combination thereof.

FIG. 5 depicts an implementation 500 in which a headset device 502 corresponds to both the device 102 and the wearable device 150 of FIG. 1. The headset device 502 includes a microphone 520 and a speaker 522. In a particular aspect, the movement tracking sensor 152 is integrated into the headset device 502. In some embodiments, the movement tracking sensor 152 can be external to the headset device 502.

Components of the one or more processors 190, including the gesture-based controller 140, are integrated into the headset device 502. In a particular example, the movement tracking sensor 152 operates to generate the sensor data 154 of FIG. 1 indicating movement of the headset device 502 (e.g., the wearable device 150). The gesture detector 142 processes the sensor data 154 to determine one or more detected gestures 156, as described with reference to FIG. 1.

The operation selector 144, based on the one or more detected gestures 156, initiates one or more operations 164 at the headset device 502, one or more other devices, or a combination thereof. In an example, the one or more operations 164 can include changing a noise-cancellation mode, toggling a microphone, raising a hand in a virtual meeting, controlling a game character movement, switching game weapons, reacting to a social media post, scrolling a social media feed, sending a notification to an emergency contact, or a combination thereof. For example, the gesture configuration data 160 can indicate that a first user-assigned gesture 162A maps to one or more first operations 164A (e.g., changing a noise-cancellation mode), a second user-assigned gesture 162B maps to one or more second operations 164B (e.g., toggling a microphone), a third user-assigned gesture 162 maps to one or more third operations 164 (e.g., raising a hand in a virtual meeting), a fourth user-assigned gesture 162 maps to one or more fourth operations 164 (e.g., controlling a game character movement), a fifth user-assigned gesture 162 maps to one or more fifth operations 164 (e.g., switching game weapons), a sixth user-assigned gesture 162 maps to one or more sixth operations 164 (e.g., reacting to a social media post), a seventh user-assigned gesture 162 maps to one or more seventh operations 164 (e.g., scrolling a social media feed), an eight user-assigned gesture 162 maps to one or more eighth operations 164 (e.g., sending a notification to an emergency contact), or a combination thereof.

FIG. 6 depicts an implementation 600 in which the device 102 includes a wearable electronic device 602, illustrated as a “smart watch.” The gesture-based controller 140 is integrated into the wearable electronic device 602.

In a particular example, the gesture detector 142 of the gesture-based controller 140 receives the sensor data 154 of FIG. 1 indicating movement of a wearable device 150. The wearable device 150 is depicted as a headset in FIG. 6 as an illustrative example, in other examples the wearable device 150 can include any type of wearable device, such as an earbud, a head-mounted display, computerized glasses, or the like. In some aspects, the gesture-based controller 140 receives first sensor data 154 from a movement tracking sensor 152 integrated into the wearable device 150, second sensor data 154 from a camera of the wearable electronic device 602, or both. To illustrate, the camera can correspond to a movement tracking sensor 152 alternatively or in addition to the movement tracking sensor 152 integrated into the wearable device 150. The gesture detector 142 processes the sensor data 154 to determine one or more detected gestures 156, as described with reference to FIG. 1.

The operation selector 144, based on the one or more detected gestures 156, initiates one or more operations 164, such as to launch a graphical user interface or otherwise display other information associated with a detected gesture 156 at a display screen 604 of the wearable electronic device 602. In some aspects, the operation selector 144 initiates one or more operations 164 at the wearable electronic device 602, the wearable device 150, another device, or a combination thereof.

In a particular example, the wearable electronic device 602 includes a haptic device that provides a haptic notification (e.g., vibrates) in response to detection of user gestures. For example, the haptic notification can cause a user to look at the display screen 604 to see a displayed notification indicating detection of a user gesture. The wearable electronic device 602 can thus alert a user with a hearing impairment or a user wearing a headset that the user's gesture is detected and that corresponding one or more operations 164 are to be initiated.

FIG. 7 depicts an implementation 700 in which a portable electronic device includes the device 102 and the wearable device 150 and corresponds to augmented reality or mixed reality glasses 702. The glasses 702 include a holographic projection unit 704 configured to project visual data onto a surface of a lens 706 or to reflect the visual data off of a surface of the lens 706 and onto the wearer's retina. The gesture-based controller 140, the movement tracking sensor 152, or both, are integrated into the glasses 702.

Components of the one or more processors 190, including the gesture-based controller 140, are integrated into the glasses 702. In a particular example, the movement tracking sensor 152 operates to generate the sensor data 154 of FIG. 1 indicating movement of the wearable device 150. The gesture detector 142 processes the sensor data 154 to determine one or more detected gestures 156, as described with reference to FIG. 1.

The operation selector 144, based on the one or more detected gestures 156, initiates one or more operations 164 at the glasses 702 (e.g., the device 102 and the wearable device 150), another device, or a combination thereof. In a particular example, the holographic projection unit 704 is configured to display a notification indicating that the one or more operations 164 are initiated responsive to a detected gesture 156. For example, the notification can be superimposed on the user's field of view.

FIG. 8 depicts an implementation of earbuds 800 operable to perform configurable gesture-based operation control, in accordance with some examples of the present disclosure. The earbuds 800 correspond to the device 102 and the wearable device 150.

The earbuds 800 include a first earbud 802A and a second earbud 802B, which can also be referred to as an earbud pair 803. Although earbuds are described, it should be understood that the present technology can be applied to other in-ear or over-ear playback devices. Although two earbuds (e.g., the first earbud 802A and the second earbud 802B) are shown in FIG. 8, in other examples, the aspects described herein may be integrated into a single earbud.

The first earbud 802A includes a first microphone 804A, such as a high signal-to-noise microphone positioned to capture the voice of a wearer of the first earbud 802A, an array of one or more other microphones configured to detect ambient sounds and spatially distributed to support beamforming, illustrated as a microphone 812A, an “inner” microphone 814A proximate to the wearer's ear canal (e.g., to assist with active noise cancelling), and a self-speech microphone 816A, such as a bone conduction microphone configured to convert sound vibrations of the wearer's ear bone or skull into an audio signal. The first earbud 802A also includes one or more speakers 806A and a first movement tracking sensor 152A.

The second earbud 802B can be configured in a substantially similar manner as the first earbud 802A. For example, the second earbud 802B may include a second microphone 804B, an array of one or more other microphones (illustrated as microphone 812B), an “inner” microphone 814B, a self-speech microphone 816B, one or more speakers 806B, and a second movement tracking sensor 152B. In some implementations, the first earbud 802A is also configured to receive sensor data from the movement tracking sensor 152B indicating movement of the second earbud 802B, such as via wireless transmission between the earbuds 802A, 802B, or via wired transmission in embodiments in which the earbuds 802A, 802B are coupled via a transmission line.

In some implementations, the earbuds 800 are configured to automatically switch between various operating modes, such as a passthrough mode in which ambient sound is played via the speakers 806A, 806B, a playback mode in which non-ambient sound (e.g., streaming audio corresponding to a phone conversation, media playback, video game, etc.) is played back through the speakers 806A, 806B, and an audio zoom mode or beamforming mode in which one or more ambient sounds are emphasized and/or other ambient sounds are suppressed for playback at the speaker 806A, 806B. In other implementations, the earbuds 800 may support fewer modes or may support one or more other modes in place of, or in addition to, the described modes.

In an illustrative example, the earbuds 800 can automatically transition from the playback mode to the passthrough mode in response to detecting the wearer's voice, and may automatically transition back to the playback mode after the wearer has ceased speaking. In some examples, the earbuds 800 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music.

In FIG. 8, the gesture-based controller 140 is integrated into the earbuds 800 and is illustrated using dashed lines to indicate internal components that are not generally visible to a user of the earbuds 800. For example, a first gesture-based controller 140A may be integrated into the first earbud 802A, and a second gesture-based controller 140B may be integrated into the second earbud 802B. In a particular example, the gesture-based controllers 140A, 140B are operable to obtain sensor data from the movement tracking sensor 152A, the movement tracking sensor 152B, or both, during operation of the earbuds 800. In some embodiments, the earbuds 800 may send the sensor data from the movement tracking sensors 152A, 152B to a user device, such as a smart phone, that is communicatively coupled to the first earbud 802A, the second earbud 802B, or both.

In a particular example, the gesture-based controller 140A obtains the first sensor data 154 from the movement tracking sensor 152A, second sensor data 154 from the movement tracking sensor 152B, or both. The gesture detector 142 of the gesture-based controller 140A processes the first sensor data 154, the second sensor data 154, or a combination thereof, to determine the detected gesture 156. The operation selector 144 of the gesture-based controller 140A, based on determining that the detected gesture 156 matches a user-assigned gesture 162A of gesture configuration data 160 and that the gesture configuration data 160 corresponds to the one or more operations 164A, initiates at least one of the operations 164A at the first earbud 802A, at least one of the operations 164A at the second earbud 802B, at least one of the operations 164A at another device (e.g., a user device), or a combination thereof. In an illustrative example, the operation selector 144, based on determining that the detected gesture 156 matches the user-assigned gesture 162A, causes the earbuds 800 to transition from a passthrough mode to a playback mode, and sends a command to a user device to accept a voice call. The user device sends audio of the voice call to the earbuds 800 and the earbuds 800 send audio from the microphones 804A, 804B to the user device.

FIG. 9 is an implementation 900 in which the device 102 includes a wireless speaker and voice activated device 902. The wireless speaker and voice activated device 902 can have wireless network connectivity and is configured to execute an assistant operation.

The one or more processors 190 including the gesture-based controller 140, a microphone 920, or both, are included in the wireless speaker and voice activated device 902. The wireless speaker and voice activated device 902 also includes a speaker 904. During operation, the gesture detector 142 of the gesture-based controller 140 receives the sensor data 154 of FIG. 1 indicating movement of a wearable device 150. The wearable device 150 is depicted as a headset in FIG. 9 as an illustrative example, in other examples the wearable device 150 can include any type of wearable device, such as an earbud, a head-mounted display, computerized glasses, or the like. In some aspects, the gesture-based controller 140 receives first sensor data 154 from a movement tracking sensor 152 integrated into the wearable device 150, second sensor data 154 from a camera of the wireless speaker and voice activated device 902, or both. To illustrate, the camera can correspond to a movement tracking sensor 152 alternatively or in addition to the movement tracking sensor 152 integrated into the wearable device 150. The gesture detector 142 processes the sensor data 154 to determine one or more detected gestures 156, as described with reference to FIG. 1. The operation selector 144, based on the one or more detected gestures 156, initiates one or more operations 164 (e.g., assistant operations), such as adjusting a temperature, playing music, turning on lights, etc.

FIG. 10 depicts an implementation 1000 in which the device 102 includes a portable electronic device that corresponds to a camera device 1002. The camera device 1002 includes the gesture-based controller 140, and optionally a microphone 1020.

During operation, the gesture detector 142 of the gesture-based controller 140 receives the sensor data 154 of FIG. 1 indicating movement of a wearable device 150. The wearable device 150 is depicted as a headset in FIG. 10 as an illustrative example, in other examples the wearable device 150 can include any type of wearable device, such as an earbud, a head-mounted display, computerized glasses, or the like. In some aspects, the gesture-based controller 140 receives first sensor data 154 from a movement tracking sensor 152 integrated into the wearable device 150, second sensor data 154 from the camera device 1002, or both. To illustrate, the camera device 1002 can correspond to or be operated to function as a movement tracking sensor 152 alternatively or in addition to the movement tracking sensor 152 integrated into the wearable device 150. The gesture detector 142 processes the sensor data 154 to determine one or more detected gestures 156, as described with reference to FIG. 1. The operation selector 144, based on the one or more detected gestures 156, initiates one or more operations 164, such as to adjust image or video capture settings, image or video playback settings, or image or video capture instructions, as illustrative examples.

FIG. 11 depicts an implementation 1100 in which a portable electronic device includes the device 102 and the wearable device 150, and corresponds to a virtual reality, mixed reality, or augmented reality headset 1102. The headset 1102 includes the gesture-based controller 140, and optionally a microphone 1120.

In a particular aspect, the movement tracking sensor 152 is integrated into the headset 1102. In some aspects, the movement tracking sensor 152 can be external to the headset 1102. A visual interface device is positioned in front of the user's eyes to enable display of augmented reality, mixed reality, or virtual reality images or scenes to the user while the headset 1102 is worn.

During operation, the movement tracking sensor 152 operates to generate the sensor data 154 of FIG. 1 indicating movement of the headset 1102 (e.g., the wearable device 150). The gesture detector 142 processes the sensor data 154 to determine one or more detected gestures 156, as described with reference to FIG. 1.

The operation selector 144, based on the one or more detected gestures 156, initiates one or more operations 164 at the headset 1102, one or more other devices, or a combination thereof. In a particular example, the visual interface device is configured to display a notification indicating the detected gesture 156, one or more operations 164 corresponding to the detected gesture 156, or a combination thereof. As an illustrative example, a doorbell camera sends an alert to the headset 1102 corresponding to a person ringing a doorbell, the gesture detector 142 determines the detected gesture 156 of the user 180 wearing the headset 1102, and the headset 1102, based on the detected gesture 156, sends a request to the doorbell camera to capture an image and send the image to the headset 1102, and the visual interface device displays the image received from the doorbell camera. In this example, the user 180 can decide whether to perform a gesture to initiate a door unlock operation, or another gesture to initiate communication via a communication device at the door.

FIG. 12 depicts an implementation 1200 in which the device 102 corresponds to, or is integrated within, a vehicle 1202, illustrated as a manned or unmanned aerial device (e.g., a package delivery drone). The gesture-based controller 140, a microphone 1220, or both, are integrated into the vehicle 1202.

In a particular example, the gesture detector 142 of the gesture-based controller 140 receives the sensor data 154 of FIG. 1 indicating movement of a wearable device 150. The wearable device 150 is depicted as a headset in FIG. 12 as an illustrative example, in other examples the wearable device 150 can include any type of wearable device, such as an earbud, a head-mounted display, computerized glasses, or the like. In some aspects, the gesture-based controller 140 receives first sensor data 154 from a movement tracking sensor 152 integrated into the wearable device 150, second sensor data 154 from a camera of the vehicle 1202, or both. To illustrate, the camera can correspond to a movement tracking sensor 152 alternatively or in addition to the movement tracking sensor 152 integrated into the wearable device 150. The gesture detector 142 processes the sensor data 154 to determine one or more detected gestures 156, as described with reference to FIG. 1.

The operation selector 144, based on the one or more detected gestures 156, initiates one or more operations 164 at the vehicle 1202, the wearable device 150, another device, or a combination thereof. For example, the user 180 can use gestures while wearing the wearable device 150 to control navigation of the vehicle 1202.

FIG. 13 depicts another implementation 1300 in which the device 102 corresponds to, or is integrated within, a vehicle 1302, illustrated as a car. The vehicle 1302 includes the one or more processors 190 including the gesture-based controller 140. The vehicle 1302 also includes a microphone 1320, a speaker 1310, and a display 1304.

In a particular example, the gesture detector 142 of the gesture-based controller 140 receives the sensor data 154 of FIG. 1 indicating movement of a wearable device 150. The wearable device 150 is depicted as a headset in FIG. 13 as an illustrative example, in other examples the wearable device 150 can include any type of wearable device, such as an earbud, a head-mounted display, computerized glasses, or the like. In some aspects, the gesture-based controller 140 receives first sensor data 154 from a movement tracking sensor 152 integrated into the wearable device 150, second sensor data 154 from a camera of the vehicle 1302, or both. To illustrate, the camera can correspond to a movement tracking sensor 152 alternatively or in addition to the movement tracking sensor 152 integrated into the wearable device 150. The gesture detector 142 processes the sensor data 154 to determine one or more detected gestures 156, as described with reference to FIG. 1.

The operation selector 144, based on the one or more detected gestures 156, initiates one or more operations 164, such as to launch a graphical user interface or otherwise display other information associated with a detected gesture 156 at the display 1304. In some aspects, the operation selector 144 initiates one or more operations 164 at the vehicle 1302, the wearable device 150, another device, or a combination thereof.

In some embodiments, the wearable device 150 is worn by an authorized passenger. For example, the gesture detection can be used to detect a command from an operator of the vehicle 1302 (e.g., from a parent to set a volume to 5 or to set a destination for a self-driving vehicle) and to disregard gestures of another passenger (e.g., a command from a child to set the volume to 10 or gestures of other passengers). In some embodiments, gesture detection can be performed based on a wearable device 150 worn by an authorized user of the vehicle 1302 who is outside the vehicle 1302.

In a particular embodiment, in response to receiving the sensor data 154 that is identified as corresponding to the detected gesture 156 via operation of the gesture detector 142, the operation selector 144 initiates one or more operations 164 of the vehicle 1302 (e.g., unlock, start engine, play music, accept a voice call, decline a voice call, navigate to home, display weather forecast, or another operation). In some examples, the one or more operations 164 include providing feedback or information via the display 1304, one or more speakers (e.g., the speaker 1310), or a combination thereof.

In a particular embodiment, in response to receiving the sensor data 154 that is identified as corresponding to the detected gesture 156 via operation of the gesture detector 142, the operation selector 144 of the vehicle 1302 initiates one or more operations 164 at a user device, such as a mobile phone. For example, the operation selector 144 sends, based on the detected gesture 156, a command to the user device to accept a voice call or decline the voice call. The user 180 can thus accept or decline the voice call without having to take eyes off the road or hands off the steering wheel.

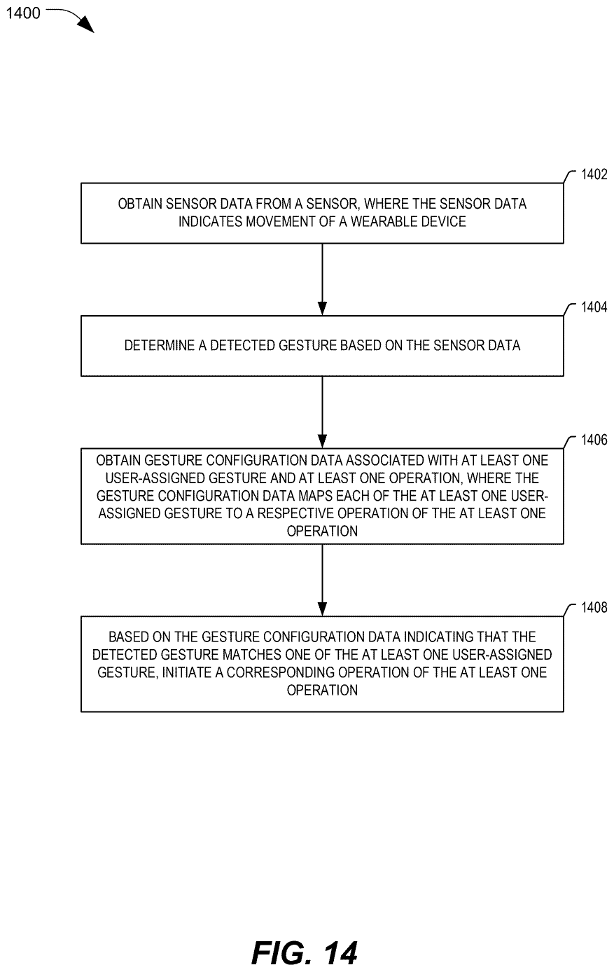

Referring to FIG. 14, a particular implementation of a method 1400 of performing configurable gesture-based operation control is shown. In a particular aspect, one or more operations of the method 1400 are performed by at least one of the movement tracking sensor 152, the gesture detector 142, the operation selector 144, the gesture-based controller 140, the one or more processors 190, the device 102, the system 100 of FIG. 1, the system 200 of FIG. 2, the integrated circuit 302 of FIG. 3, the mobile device 402 of FIG. 4, the headset device 502 of FIG. 5, the wearable electronic device 602 of FIG. 6, the glasses 702 of FIG. 7, the first earbud 802A, the second earbud 802B of FIG. 8, the wireless speaker and voice activated device 902 of FIG. 9, the camera device 1002 of FIG. 10, the headset 1102 of FIG. 11, the vehicle 1202 of FIG. 12, the vehicle 1302 of FIG. 13, or a combination thereof.

The method 1400 includes, at 1402, obtaining sensor data from a sensor, where the sensor data indicates movement of a wearable device. For example, the gesture detector 142 of FIG. 1 obtains the sensor data 154 from the movement tracking sensor 152, where the sensor data 154 indicates movement of the wearable device 150, as described with reference to FIG. 1.

The method 1400 also includes, at 1404, determining a detected gesture based on the sensor data. For example, the gesture detector 142 of FIG. 1 determines one or more detected gestures 156 based on the sensor data 154, as described with reference to FIG. 1.

The method 1400 further includes, at 1406, obtaining gesture configuration data associated with at least one user-assigned gesture and at least one operation, where the gesture configuration data maps each of the at least one user-assigned gesture to a respective operation of the at least one operation. For example, the operation selector 144 of FIG. 1 obtains the gesture configuration data 160 associated with one or more user-assigned gestures 162 and one or more operations 164. The gesture configuration data 160 maps each of the one or more user-assigned gestures 162 to a respective operation of the one or more operations 164, as described with reference to FIG. 1. For example, the gesture configuration data 160 maps the user-assigned gesture 162A to the one or more operations 164A. As another example, the gesture configuration data 160 maps the user-assigned gesture 162B to the one or more operations 164B.

The method 1400 also includes, at 1408, based on the gesture configuration data indicating that the detected gesture matches one of the at least one user-assigned gesture, initiating a corresponding operation of the at least one operation. For example, the operation selector 144 of FIG. 1, based on the gesture configuration data 160 indicated that a detected gesture 156 matches the user-assigned gesture 162A, initiates the one or more operations 164A (e.g., as the one or more operations 158), as described with reference to FIG. 1.

A technical advantage of the method 1400 thus includes providing the user 180 with non-verbal and hands-free operation control of one or more applications while wearing the wearable device 150. To illustrate, the user 180 can use gestures (e.g., head movements) to control operations at the device 102, the wearable device 150, another device, or a combination thereof. For example, the user 180 can answer a voice call without having to stop doing something else and/or without waiting for a delay associated with completing a current task that prevents them from interacting with the device 102. To illustrate, the user 180 can answer the voice call while driving without having to take eyes off the road or hands off the steering wheel. As another example, the user 180 can quietly use a gesture to trigger a camera without spoiling a moment with a verbal command.

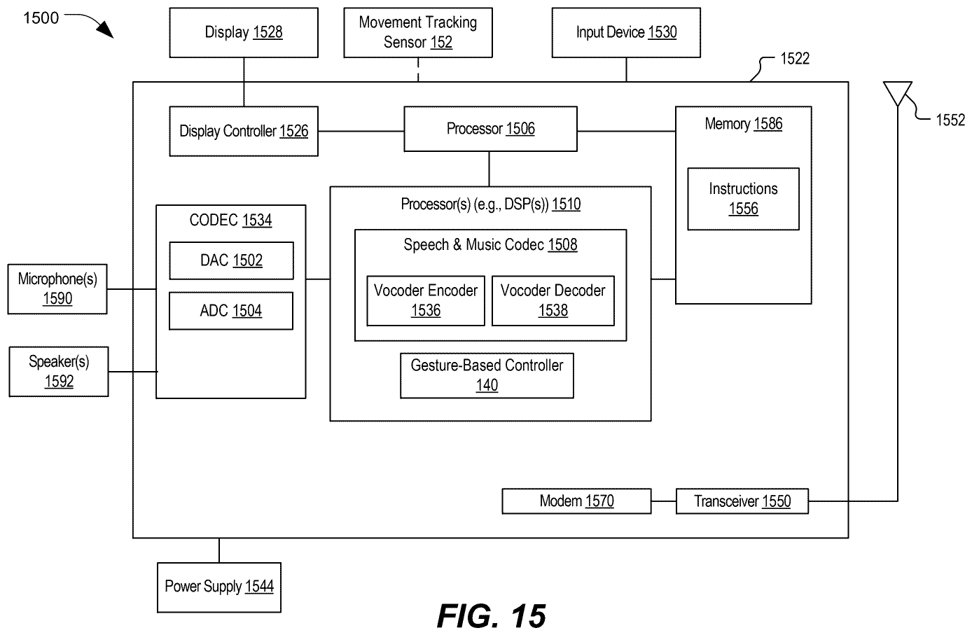

The method 1400 of FIG. 14 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1400 of FIG. 14 may be performed by a processor that executes instructions, such as described with reference to FIG. 15.

Referring to FIG. 15, a block diagram of a particular illustrative implementation of a device is depicted and generally designated 1500. In various implementations, the device 1500 may have more or fewer components than illustrated in FIG. 15. In an illustrative implementation, the device 1500 may correspond to the device 102, the wearable device 150 of FIG. 1, or both. In an illustrative implementation, the device 1500 may perform one or more operations described with reference to FIGS. 1-14.

In a particular embodiment, the device 1500 includes a processor 1506 (e.g., a CPU). The device 1500 may include one or more additional processors 1510 (e.g., one or more DSPs). In a particular aspect, the one or more processors 190 of FIG. 1 corresponds to the processor 1506, the processors 1510, or a combination thereof. The processors 1510 may include a speech and music coder-decoder (CODEC) 1508 that includes a voice coder (“vocoder”) encoder 1536, a vocoder decoder 1538, or both. The processors 1510 may include the gesture-based controller 140.

The device 1500 may include a memory 1586 and a CODEC 1534. The memory 1586 may include instructions 1556, that are executable by the one or more additional processors 1510 (or the processor 1506) to implement the functionality described with reference to the gesture-based controller 140. In a particular aspect, the memory 1586 corresponds to the memory 132 of FIG. 1. In a particular aspect, the memory 1586 is configured to store data used or generated by one or more components of the gesture-based controller 140, as described with reference to FIGS. 1-14. The device 1500 may include a modem 1570 coupled, via a transceiver 1550, to an antenna 1552.

In some embodiments, the movement tracking sensor 152 is integrated into the device 1500. In some embodiments, the movement tracking sensor 152 is wirelessly coupled to the device 1500. In some embodiments, the device 1500 receives the sensor data 154, via the modem 1570, the transceiver 1550, and the antenna 1552, from the movement tracking sensor 152.

The device 1500 may include a display 1528 coupled to a display controller 1526. One or more speakers 1592, one or more microphone 1590, or a combination thereof may be coupled to the CODEC 1534. The CODEC 1534 may include a digital-to-analog converter (DAC) 1502, an analog-to-digital converter (ADC) 1504, or both. In a particular embodiment, the CODEC 1534 may receive analog signals from the one or more microphones 1590, convert the analog signals to digital signals using the ADC 1504, and provide the digital signals to the speech and music codec 1508. The speech and music codec 1508 may process the digital signals. In a particular embodiment, the speech and music codec 1508 may provide digital signals to the CODEC 1534. The CODEC 1534 may convert the digital signals to analog signals using the DAC 1502 and may provide the analog signals to the one or more speakers 1592.

In a particular embodiment, the device 1500 may be included in a system-in-package or system-on-chip device 1522. In a particular embodiment, the memory 1586, the processor 1506, the processors 1510, the display controller 1526, the CODEC 1534, and the modem 1570 are included in the system-in-package or system-on-chip device 1522. In a particular embodiment, the movement tracking sensor 152, an input device 1530, and a power supply 1544 are coupled to the system-in-package or the system-on-chip device 1522. Moreover, in a particular embodiment, as illustrated in FIG. 15, the display 1528, the input device 1530, the movement tracking sensor 152, the one or more speakers 1592, the one or more microphones 1590, the antenna 1552, and the power supply 1544 are external to the system-in-package or the system-on-chip device 1522. In a particular embodiment, each of the display 1528, the input device 1530, the movement tracking sensor 152, the one or more speakers 1592, the one or more microphones 1590, the antenna 1552, and the power supply 1544 may be coupled to a component of the system-in-package or the system-on-chip device 1522, such as an interface or a controller.

The device 1500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described embodiments, an apparatus includes means for obtaining sensor data from a sensor, where the sensor data indicates movement of a wearable device. For example, the means for obtaining the sensor data can correspond to the wearable device 150, the movement tracking sensor 152, the gesture detector 142, the gesture-based controller 140, the one or more processors 190, the device 102, the system 100 of FIG. 1, the system 200 of FIG. 2, the integrated circuit 302 of FIG. 3, the mobile device 402 of FIG. 4, the headset device 502 of FIG. 5, the wearable electronic device 602 of FIG. 6, the glasses 702 of FIG. 7, the first earbud 802A, the second earbud 802B of FIG. 8, the wireless speaker and voice activated device 902 of FIG. 9, the camera device 1002 of FIG. 10, the headset 1102 of FIG. 11, the vehicle 1202 of FIG. 12, the vehicle 1302 of FIG. 13, the processor 1506, the processor(s) 1510, the antenna 1552, the transceiver 1550, the modem 1570, the device 1500, one or more other circuits or components configured to obtain sensor data, or any combination thereof.

The apparatus also includes means for determining a detected gesture based on the sensor data. For example, the means for determining the detected gesture can correspond to the wearable device 150, the gesture detector 142, the gesture-based controller 140, the one or more processors 190, the device 102, the system 100 of FIG. 1, the system 200 of FIG. 2, the integrated circuit 302 of FIG. 3, the mobile device 402 of FIG. 4, the headset device 502 of FIG. 5, the wearable electronic device 602 of FIG. 6, the glasses 702 of FIG. 7, the first earbud 802A, the second earbud 802B of FIG. 8, the wireless speaker and voice activated device 902 of FIG. 9, the camera device 1002 of FIG. 10, the headset 1102 of FIG. 11, the vehicle 1202 of FIG. 12, the vehicle 1302 of FIG. 13, the processor 1506, the processor(s) 1510, the device 1500, one or more other circuits or components configured to determine a detected gesture, or any combination thereof.

The apparatus further includes means for obtaining gesture configuration data associated with at least one user-assigned gesture and at least one operation, where the gesture configuration data maps each of the at least one user-assigned gesture to a respective operation of the at least one operation. For example, the means for obtaining gesture configuration data can correspond to the wearable device 150, the operation selector 144, the gesture-based controller 140, the one or more processors 190, the device 102, the system 100 of FIG. 1, the system 200 of FIG. 2, the integrated circuit 302 of FIG. 3, the mobile device 402 of FIG. 4, the headset device 502 of FIG. 5, the wearable electronic device 602 of FIG. 6, the glasses 702 of FIG. 7, the first earbud 802A, the second earbud 802B of FIG. 8, the wireless speaker and voice activated device 902 of FIG. 9, the camera device 1002 of FIG. 10, the headset 1102 of FIG. 11, the vehicle 1202 of FIG. 12, the vehicle 1302 of FIG. 13, the processor 1506, the processor(s) 1510, the device 1500, one or more other circuits or components configured to obtain the gesture configuration data, or any combination thereof.

The apparatus also includes means for initiating, based on the gesture configuration data indicating that the detected gesture matches one of the at least one user-assigned gesture, a corresponding operation of the at least one operation. For example, the means for initiating the corresponding operation can correspond to the wearable device 150, the operation selector 144, the gesture-based controller 140, the one or more processors 190, the device 102, the system 100 of FIG. 1, the system 200 of FIG. 2, the integrated circuit 302 of FIG. 3, the mobile device 402 of FIG. 4, the headset device 502 of FIG. 5, the wearable electronic device 602 of FIG. 6, the glasses 702 of FIG. 7, the first earbud 802A, the second earbud 802B of FIG. 8, the wireless speaker and voice activated device 902 of FIG. 9, the camera device 1002 of FIG. 10, the headset 1102 of FIG. 11, the vehicle 1202 of FIG. 12, the vehicle 1302 of FIG. 13, the processor 1506, the processor(s) 1510, the antenna 1552, the transceiver 1550, the modem 1570, the device 1500, one or more other circuits or components configured to initiate a corresponding operation, or any combination thereof.

In some embodiments, a non-transitory computer-readable medium (e.g., a computer-readable storage device, such as the memory 1586) includes instructions (e.g., the instructions 1556) that, when executed by one or more processors (e.g., the one or more processors 1510 or the processor 1506), cause the one or more processors to obtain sensor data (e.g., the sensor data 154) from a sensor (e.g., the movement tracking sensor 152), where the sensor data indicates movement of a wearable device (e.g., the wearable device 150). The instructions further cause the one or more processors to determine a detected gesture (e.g., the detected gesture 156) based on the sensor data. The instructions further cause the one or more processors to obtain gesture configuration data (e.g., the gesture configuration data 160) associated with at least one user-assigned gesture (e.g., the one or more user-assigned gestures 162) and at least one operation (e.g., the one or more operations 164), where the gesture configuration data maps each of the at least one user-assigned gesture to a respective operation of the at least one operation. The instructions further cause the one or more processors to, based on the gesture configuration data indicating that the detected gesture matches one of the at least one user-assigned gesture, initiate a corresponding operation of the at least one operation.

Particular aspects of the disclosure are described below in sets of interrelated Examples:
According to Example 1, a device includes: a memory configured to store gesture configuration data associated with at least one user-assigned gesture and at least one operation, wherein the gesture configuration data maps each of the at least one user-assigned gesture to a respective operation of the at least one operation; and one or more processors coupled to the memory and configured to: obtain sensor data from a sensor, wherein the sensor data indicates movement of a wearable device; determine a detected gesture based on the sensor data; and based on the gesture configuration data indicating that the detected gesture matches one of the at least one user-assigned gesture, initiate a corresponding operation of the at least one operation.
Example 2 includes the device of Example 1, wherein the wearable device includes an earbud or a headset.
Example 3 includes the device of Example 1 or Example 2, wherein the detected gesture corresponds to a head movement.
Example 4 includes the device of any of Examples 1 to 3, and further includes an interface configured to receive the sensor data from the wearable device.
Example 5 includes the device of any of Examples 1 to 4, wherein the one or more processors and the sensor are integrated into the wearable device.
Example 6 includes the device of any of Examples 1 to 5, wherein, to initiate the corresponding operation, the one or more processors are configured to send a command associated with the corresponding operation to the wearable device.
Example 7 includes the device of any of Examples 1 to 6, wherein the one or more processors are configured to perform the corresponding operation.
Example 8 includes the device of any of Examples 1 to 7, wherein the one or more processors are configured to use a machine learning (ML) model to process the sensor data to determine the detected gesture.
Example 9 includes the device of Example 8, wherein the one or more processors are configured to: output an indicator of the detected gesture; and based on receiving a user input indicating an intended gesture that does not match the detected gesture, selectively update the ML model based on the sensor data and the intended gesture.
Example 10 includes the device of any of Examples 1 to 9, further comprising the sensor configured to track movement, wherein the sensor includes an accelerometer, a gyroscope, a magnetometer, or a combination thereof.
Example 11 includes the device of any of Examples 1 to 10, wherein the sensor data indicates yaw, pitch, and roll of the wearable device.
Example 12 includes the device of any of Examples 1 to 11, wherein the one or more processors are configured to: generate a spatial audio output based on the sensor data; and provide the spatial audio output to the wearable device.
Example 13 includes the device of any of Examples 1 to 12, wherein the one or more processors are configured to receive a user input indicating a user-assigned operation to be associated with the detected gesture; and update the gesture configuration data to map the detected gesture to the user-assigned operation.
Example 14 includes the device of any of Examples 1 to 13, wherein the one or more processors are configured to: detect that a voice call is being received; and determine, based on whether the detected gesture matches a first head movement or a second head movement, whether to accept or decline the voice call, wherein the at least one user-assigned gesture includes the first head movement and the second head movement, and wherein the gesture configuration data indicates that the first head movement corresponds to a call acceptance operation and that the second head movement corresponds to a call decline operation.
Example 15 includes the device of any of Examples 1 to 14, wherein the one or more processors are configured to determine, based on whether the detected gesture matches a clockwise head rotation or an anti-clockwise head rotation, whether to initiate performance of a first operation of the at least one operation or a second operation of the at least one operation, wherein the at least one user-assigned gesture includes the clockwise head rotation and the anti-clockwise head rotation, and wherein the gesture configuration data indicates that the clockwise head rotation corresponds to the first operation and that the anti-clockwise head rotation corresponds to the second operation.
Example 16 includes the device of any of Examples 1 to 15, wherein the at least one user-assigned gesture includes a head shake, a head tilt, a nod, a clockwise head rotation, an anti-clockwise head rotation, or a combination thereof.
Example 17 includes the device of any of Examples 1 to 16, wherein the at least one operation includes shuffling a playlist, switching a music genre, adding a song to the playlist, transitioning to another song of the playlist, changing a selected language, changing a noise-cancellation mode, toggling a microphone, raising a hand in a virtual meeting, controlling a game character movement, switching game weapons, reacting to a social media post, scrolling a social media feed, sending a notification to an emergency contact, or a combination thereof.
According to Example 18, a method includes: obtaining, at a device, sensor data from a sensor, wherein the sensor data indicates movement of a wearable device; determining, at the device, a detected gesture based on the sensor data; obtaining, at the device, gesture configuration data associated with at least one user-assigned gesture and at least one operation, wherein the gesture configuration data maps each of the at least one user-assigned gesture to a respective operation of the at least one operation; and based on the gesture configuration data indicating that the detected gesture matches one of the at least one user-assigned gesture, initiating a corresponding operation of the at least one operation.
Example 19 includes the method of Example 18, wherein the wearable device includes an earbud or a headset.
Example 20 includes the method of Example 18 or Example 19, wherein the detected gesture corresponds to a head movement.
Example 21 includes the method of any of Examples 18 to 20, and further includes receiving, using an interface, the sensor data from the wearable device.
Example 22 includes the method of any of Examples 18 to 21, wherein the wearable device includes the device.
Example 23 includes the method of any of Examples 18 to 22, and further includes, to initiate the corresponding operation, sending a command associated with the corresponding operation to the wearable device.
Example 24 includes the method of any of Examples 18 to 23 and further includes performing the corresponding operation.
Example 25 includes the method of any of Examples 18 to 24 and further includes using a machine learning (ML) model to process the sensor data to determine the detected gesture.
Example 26 includes the method of Example 25 and further includes: outputting an indicator of the detected gesture; and based on receiving a user input indicating an intended gesture that does not match the detected gesture, selectively updating the ML model based on the sensor data and the intended gesture.
Example 27 includes the method of any of Examples 18 to 26, wherein the sensor includes an accelerometer, a gyroscope, a magnetometer, or a combination thereof.
Example 28 includes the method of any of Examples 18 to 27, wherein the sensor data indicates yaw, pitch, and roll of the wearable device.
Example 29 includes the method of any of Examples 18 to 28 and further includes: generating a spatial audio output based on the sensor data; and providing the spatial audio output to the wearable device.
Example 30 includes the method of any of Examples 18 to 29 and further includes: receiving a user input indicating a user-assigned operation to be associated with the detected gesture; and updating the gesture configuration data to map the detected gesture to the user-assigned operation.
Example 31 includes the method of any of Examples 18 to 30 and further includes: detecting that a voice call is being received; and determining, based on whether the detected gesture matches a first head movement or a second head movement, whether to accept or decline the voice call, wherein the at least one user-assigned gesture includes the first head movement and the second head movement, and wherein the gesture configuration data indicates that the first head movement corresponds to a call acceptance operation and that the second head movement corresponds to a call decline operation.
Example 32 includes the method of any of Examples 18 to 31 and further includes determining, based on whether the detected gesture matches a clockwise head rotation or an anti-clockwise head rotation, whether to initiate performance of a first operation of the at least one operation or a second operation of the at least one operation, wherein the at least one user-assigned gesture includes the clockwise head rotation and the anti-clockwise head rotation, and wherein the gesture configuration data indicates that the clockwise head rotation corresponds to the first operation and that the anti-clockwise head rotation corresponds to the second operation.
Example 33 includes the method of any of Examples 18 to 32, wherein the at least one user-assigned gesture includes a head shake, a head tilt, a nod, a clockwise head rotation, an anti-clockwise head rotation, or a combination thereof.
Example 34 includes the method of any of Examples 18 to 33, wherein the at least one operation includes shuffling a playlist, switching a music genre, adding a song to the playlist, transitioning to another song of the playlist, changing a selected language, changing a noise-cancellation mode, toggling a microphone, raising a hand in a virtual meeting, controlling a game character movement, switching game weapons, reacting to a social media post, scrolling a social media feed, sending a notification to an emergency contact, or a combination thereof.
According to Example 35, a non-transitory computer-readable medium stores instructions that, when executed by one or more processors, cause the one or more processors to: obtain sensor data from a sensor, wherein the sensor data indicates movement of a wearable device; determine a detected gesture based on the sensor data; obtain gesture configuration data associated with at least one user-assigned gesture and at least one operation, wherein the gesture configuration data maps each of the at least one user-assigned gesture to a respective operation of the at least one operation; and based on the gesture configuration data indicating that the detected gesture matches one of the at least one user-assigned gesture, initiate a corresponding operation of the at least one operation.
Example 36 includes the non-transitory computer-readable medium of Example 35, wherein the wearable device includes an earbud or a headset.
Example 37 includes the non-transitory computer-readable medium of Example 35 or Example 36, wherein the detected gesture corresponds to a head movement.
Example 38 includes the non-transitory computer-readable medium of any of Examples 35 to 37, wherein the instructions, when executed by the one or more processors, cause the one or more processors to receive, using an interface, the sensor data from the wearable device.
Example 39 includes the non-transitory computer-readable medium of any of Examples 35 to 38, wherein the one or more processors and the sensor are integrated into the wearable device.
Example 40 includes the non-transitory computer-readable medium of any of Examples 35 to 39, wherein the instructions, when executed by the one or more processors, cause the one or more processors to, to initiate the corresponding operation, send a command associated with the corresponding operation to the wearable device.
Example 41 includes the non-transitory computer-readable medium of any of Examples 35 to 40, wherein the instructions, when executed by the one or more processors, cause the one or more processors to perform the corresponding operation.
Example 42 includes the non-transitory computer-readable medium of any of Examples 35 to 41, wherein the instructions, when executed by the one or more processors, cause the one or more processors to use a machine learning (ML) model to process the sensor data to determine the detected gesture.
Example 43 includes the non-transitory computer-readable medium of Example 42, wherein the instructions, when executed by the one or more processors, cause the one or more processors to: output an indicator of the detected gesture; and based on receiving a user input indicating an intended gesture that does not match the detected gesture, selectively update the ML model based on the sensor data and the intended gesture.
Example 44 includes the non-transitory computer-readable medium of any of Examples 35 to 43, wherein the sensor includes an accelerometer, a gyroscope, a magnetometer, or a combination thereof.
Example 45 includes the non-transitory computer-readable medium of any of Examples 35 to 44, wherein the sensor data indicates yaw, pitch, and roll of the wearable device.
Example 46 includes the non-transitory computer-readable medium of any of Examples 35 to 45, wherein the instructions, when executed by the one or more processors, cause the one or more processors to generate a spatial audio output based on the sensor data; and provide the spatial audio output to the wearable device.
Example 47 includes the non-transitory computer-readable medium of any of Examples 35 to 46, wherein the instructions, when executed by the one or more processors, cause the one or more processors to: receive a user input indicating a user-assigned operation to be associated with the detected gesture; and update the gesture configuration data to map the detected gesture to the user-assigned operation.
Example 48 includes the non-transitory computer-readable medium of any of Examples 35 to 47, wherein the instructions, when executed by the one or more processors, cause the one or more processors to: detect that a voice call is being received; and determine, based on whether the detected gesture matches a first head movement or a second head movement, whether to accept or decline the voice call, wherein the at least one user-assigned gesture includes the first head movement and the second head movement, and wherein the gesture configuration data indicates that the first head movement corresponds to a call acceptance operation and that the second head movement corresponds to a call decline operation.
Example 49 includes the non-transitory computer-readable medium of any of Examples 35 to 48, wherein the instructions, when executed by the one or more processors, cause the one or more processors to determine, based on whether the detected gesture matches a clockwise head rotation or an anti-clockwise head rotation, whether to initiate performance of a first operation of the at least one operation or a second operation of the at least one operation, wherein the at least one user-assigned gesture includes the clockwise head rotation and the anti-clockwise head rotation, and wherein the gesture configuration data indicates that the clockwise head rotation corresponds to the first operation and that the anti-clockwise head rotation corresponds to the second operation.
Example 50 includes the non-transitory computer-readable medium of any of Examples 35 to 49, wherein the at least one user-assigned gesture includes a head shake, a head tilt, a nod, a clockwise head rotation, an anti-clockwise head rotation, or a combination thereof.
Example 51 includes the non-transitory computer-readable medium of any of Examples 35 to 50, wherein the at least one operation includes shuffling a playlist, switching a music genre, adding a song to the playlist, transitioning to another song of the playlist, changing a selected language, changing a noise-cancellation mode, toggling a microphone, raising a hand in a virtual meeting, controlling a game character movement, switching game weapons, reacting to a social media post, scrolling a social media feed, sending a notification to an emergency contact, or a combination thereof.
According to Example 52, an apparatus includes: means for obtaining sensor data from a sensor, wherein the sensor data indicates movement of a wearable device; means for determining a detected gesture based on the sensor data; means for obtaining gesture configuration data associated with at least one user-assigned gesture and at least one operation, wherein the gesture configuration data maps each of the at least one user-assigned gesture to a respective operation of the at least one operation; and means for initiating, based on the gesture configuration data indicating that the detected gesture matches one of the at least one user-assigned gesture, a corresponding operation of the at least one operation.
Example 53 includes the apparatus of Example 52, wherein the wearable device includes an earbud or a headset.
Example 54 includes the apparatus of Example 52 or Example 53, wherein the detected gesture corresponds to a head movement.
Example 55 includes the apparatus of any of Examples 52 to 54 and further includes means for receiving, using an interface, the sensor data from the wearable device.
Example 56 includes the apparatus of any of Examples 52 to 55, wherein at least one of the sensor, the means for obtaining the sensor data, the means for determining the detected gesture, the means for obtaining the gesture configuration data, or the means for initiating are integrated into the wearable device.
Example 57 includes the apparatus of any of Examples 52 to 56 and further includes means for sending, to initiate the corresponding operation, a command associated with the corresponding operation to the wearable device.
Example 58 includes the apparatus of any of Examples 52 to 57 and further includes means for performing the corresponding operation.
Example 59 includes the apparatus of any of Examples 52 to 58 and further includes means for using a machine learning (ML) model to process the sensor data to determine the detected gesture.
Example 60 includes the apparatus of Example 59, further includes: means for outputting an indicator of the detected gesture; and means for selectively updating the ML model based on the sensor data and the intended gesture, wherein the ML model is updated based on receiving a user input indicating an intended gesture that does not match the detected gesture.
Example 61 includes the apparatus of any of Examples 52 to 60, wherein the sensor includes an accelerometer, a gyroscope, a magnetometer, or a combination thereof.
Example 62 includes the apparatus of any of Examples 52 to 61, wherein the sensor data indicates yaw, pitch, and roll of the wearable device.
Example 63 includes the apparatus of any of Examples 52 to 62, further includes means for generating a spatial audio output based on the sensor data; and means for providing the spatial audio output to the wearable device.
Example 64 includes the apparatus of any of Examples 52 to 63, further includes: means for receiving a user input indicating a user-assigned operation to be associated with the detected gesture; and means for updating the gesture configuration data to map the detected gesture to the user-assigned operation.
Example 65 includes the apparatus of any of Examples 52 to 64, further includes: means for detecting that a voice call is being received; and means for determining, based on whether the detected gesture matches a first head movement or a second head movement, whether to accept or decline the voice call, wherein the at least one user-assigned gesture includes the first head movement and the second head movement, and wherein the gesture configuration data indicates that the first head movement corresponds to a call acceptance operation and that the second head movement corresponds to a call decline operation.
Example 66 includes the apparatus of any of Examples 52 to 65 and further includes means for determining, based on whether the detected gesture matches a clockwise head rotation or an anti-clockwise head rotation, whether to initiate performance of a first operation of the at least one operation or a second operation of the at least one operation, wherein the at least one user-assigned gesture includes the clockwise head rotation and the anti-clockwise head rotation, and wherein the gesture configuration data indicates that the clockwise head rotation corresponds to the first operation and that the anti-clockwise head rotation corresponds to the second operation.
Example 67 includes the apparatus of any of Examples 52 to 66, wherein the at least one user-assigned gesture includes a head shake, a head tilt, a nod, a clockwise head rotation, an anti-clockwise head rotation, or a combination thereof.
Example 68 includes the apparatus of any of Examples 52 to 67, wherein the at least one operation includes shuffling a playlist, switching a music genre, adding a song to the playlist, transitioning to another song of the playlist, changing a selected language, changing a noise-cancellation mode, toggling a microphone, raising a hand in a virtual meeting, controlling a game character movement, switching game weapons, reacting to a social media post, scrolling a social media feed, sending a notification to an emergency contact, or a combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store gesture configuration data associated with at least one user-assigned gesture and at least one operation, wherein the gesture configuration data maps each of the at least one user-assigned gesture to a respective operation of the at least one operation; and
one or more processors coupled to the memory and configured to:
obtain sensor data from a sensor, wherein the sensor data indicates movement of a wearable device;
determine a detected gesture based on the sensor data; and
based on the gesture configuration data indicating that the detected gesture matches one of the at least one user-assigned gesture, initiate a corresponding operation of the at least one operation.

2. The device of claim 1, wherein the wearable device includes an earbud or a headset.

3. The device of claim 1, wherein the detected gesture corresponds to a head movement.

4. The device of claim 1, further comprising an interface configured to receive the sensor data from the wearable device.

5. The device of claim 1, wherein the one or more processors and the sensor are integrated into the wearable device.

6. The device of claim 1, wherein, to initiate the corresponding operation, the one or more processors are configured to send a command associated with the corresponding operation to the wearable device.

7. The device of claim 1, wherein the one or more processors are configured to perform the corresponding operation.

8. The device of claim 1, wherein the one or more processors are configured to use a machine learning (ML) model to process the sensor data to determine the detected gesture.

9. The device of claim 8, wherein the one or more processors are configured to:
output an indicator of the detected gesture; and
based on receiving a user input indicating an intended gesture that does not match the detected gesture, selectively update the ML model based on the sensor data and the intended gesture.

10. The device of claim 1, further comprising the sensor configured to track movement, wherein the sensor includes an accelerometer, a gyroscope, a magnetometer, or a combination thereof.

11. The device of claim 1, wherein the sensor data indicates yaw, pitch, and roll of the wearable device.

12. The device of claim 1, wherein the one or more processors are configured to:
generate a spatial audio output based on the sensor data; and
provide the spatial audio output to the wearable device.

13. The device of claim 1, wherein the one or more processors are configured to:
receive a user input indicating a user-assigned operation to be associated with the detected gesture; and
update the gesture configuration data to map the detected gesture to the user-assigned operation.

14. The device of claim 1, wherein the one or more processors are configured to:
detect that a voice call is being received; and
determine, based on whether the detected gesture matches a first head movement or a second head movement, whether to accept or decline the voice call, wherein the at least one user-assigned gesture includes the first head movement and the second head movement, and wherein the gesture configuration data indicates that the first head movement corresponds to a call acceptance operation and that the second head movement corresponds to a call decline operation.

15. The device of claim 1, wherein the one or more processors are configured to determine, based on whether the detected gesture matches a clockwise head rotation or an anti-clockwise head rotation, whether to initiate performance of a first operation of the at least one operation or a second operation of the at least one operation, wherein the at least one user-assigned gesture includes the clockwise head rotation and the anti-clockwise head rotation, and wherein the gesture configuration data indicates that the clockwise head rotation corresponds to the first operation and that the anti-clockwise head rotation corresponds to the second operation.

16. The device of claim 1, wherein the at least one user-assigned gesture includes a head shake, a head tilt, a nod, a clockwise head rotation, an anti-clockwise head rotation, or a combination thereof.

17. The device of claim 1, wherein the at least one operation includes shuffling a playlist, switching a music genre, adding a song to the playlist, transitioning to another song of the playlist, changing a selected language, changing a noise-cancellation mode, toggling a microphone, raising a hand in a virtual meeting, controlling a game character movement, switching game weapons, reacting to a social media post, scrolling a social media feed, sending a notification to an emergency contact, or a combination thereof.

18. A method comprising:
obtaining, at a device, sensor data from a sensor, wherein the sensor data indicates movement of a wearable device;
determining, at the device, a detected gesture based on the sensor data;
obtaining, at the device, gesture configuration data associated with at least one user-assigned gesture and at least one operation, wherein the gesture configuration data maps each of the at least one user-assigned gesture to a respective operation of the at least one operation; and
based on the gesture configuration data indicating that the detected gesture matches one of the at least one user-assigned gesture, initiating a corresponding operation of the at least one operation.

19. The method of claim 18, further comprising using a machine learning (ML) model to process the sensor data to determine the detected gesture.

20. A non-transitory computer-readable medium storing instructions that, when executed by one or more processors, cause the one or more processors to:
obtain sensor data from a sensor, wherein the sensor data indicates movement of a wearable device;
determine a detected gesture based on the sensor data;
obtain gesture configuration data associated with at least one user-assigned gesture and at least one operation, wherein the gesture configuration data maps each of the at least one user-assigned gesture to a respective operation of the at least one operation; and
based on the gesture configuration data indicating that the detected gesture matches one of the at least one user-assigned gesture, initiate a corresponding operation of the at least one operation.
